(19) United States
(12) Patent Application Publication
(10) Pub. No.: US 2013/0195372 A1
(43) Pub. Date: Aug. 1, 2013

(54) IMAGE PROCESSING APPARATUS AND METHOD

(71) Applicant: Kazuya Ogawa, Tokyo (JP)

(72) Inventor: Kazuya Ogawa, Tokyo (JP)

(21) Appl. No.: 13/639,247

(22) PCT Filed: Mar. 31, 2011
(86) PCT No.: PCT/JP2011/058165

§ 371 Date: Oct. 25, 2012

(30) Foreign Application Priority Data
Apr. 9, 2010 (JP) 2010-090959

(51) Int. Cl. G06T 9/00

(52) U.S. Cl. CPC G06T 9/004
USPC 382/238

(57) ABSTRACT

The present disclosure relates to an image processing apparatus and method, which can improve the coding efficiency while suppressing an increase in the load.

Included are: a region setting unit for setting a size in a vertical direction of a partial region to be a process unit upon coding an image as a fixed value and setting a size in a horizontal direction thereof depending on a value of a parameter of the image; a predicted image generation unit for generating a predicted image using the partial region set by the region setting unit as a process unit; and a coding unit for coding the image by use of a predicted image generated by the predicted image generation unit. The present technology can be applied to an image processing apparatus, for example.

### TECHNICAL FIELD

The present disclosure relates to an image processing apparatus and method, and particularly relates to an image processing apparatus and method, which can improve the coding efficiency while suppressing an increase in the load.

### BACKGROUND ART

In recent years, an apparatus in compliance with schemes such as MPEG (Moving Picture Experts Group) that handles image information digitally and at that time compresses the information by an orthogonal transformation such as the discrete cosine transform and motion compensation by use of the redundancy that is unique to image information for the purpose of high-efficient transmission and storage of information is becoming widespread in both of the distribution of information from a broadcasting station and the like and the reception of information at an ordinary home.

Especially, MPEG2 (ISO (International Organization for Standardization)/IEC (International Electrotechnical Commission) 13818-2) is defined as a generic image coding scheme, and is a standard that covers both of an interlaced scan image and a progressive scan image, and a standard resolution image and a high resolution image, the standard being currently and widely used for a wide range of applications for professional use and consumer use. The use of the MPEG2 compression scheme makes it possible to realize a high compression rate and excellent image quality by allocating, for example, an amount of code (bit rate) of 4 to 8 Mbps in the case of an interlaced scan image at standard resolution having 720×480 pixels and 18 to 22 Mbps in the case of an interlaced scan image at high resolution having 1920×1088 pixels.

MPEG2 is mainly targeted for high-quality coding compatible with that for broadcasting but does not comply with a coding scheme of a lower amount of code (bit rate), that is, a higher compression rate, than MPEG1. With the spread of mobile terminals, demand for such a coding scheme is predicted to increase in the future, and in order to handle this, the standardization of the MPEG4 coding scheme has been achieved. The specification of the image coding scheme was approved to be the international standard as ISO/IEC 14496-2 in December 1998.

Furthermore, in recent years, a standard called H.26L (ITU-T (International Telecommunication Union Telecommunication Standardization Sector) Q6/16 VCEG (Video Coding Expert Group)) is being standardized originally for the purpose of image coding for teleconferencing. Compared with a conventional coding scheme such as MPEG2 and MPEG4, it is known that H.26L requires more computation amount for coding and decoding, but realizes higher coding efficiency. Moreover, as part of activities of MPEG4, a standardization to take in also functions that are not supported in H.26L and realize higher coding efficiency is currently being carried out as Joint Model of Enhanced-Compression Video Coding, based on H.26L.

According to the schedule of the standardization, it became an international standard under the name of H.264 and MPEG-4 Part10 (Advanced Video Coding, hereinafter described as AVC) in March 2003.

Furthermore, as an extension thereof, the standardization of FRExt (Fidelity Range Extension) also including coding tools necessary for business, such as RGB, and 4:2:2 and 4:4:4, and 8×8 DCT and a quantization matrix, which are specified in MPEG2, was completed in February 2005, and accordingly, the coding scheme became possible to excellently express even film noise included in a movie by use of AVC, and was brought into use for a wide variety of applications such as Blu-Ray Disc.

However, demand for coding with a higher compression rate such as a desire to compress an image of approximately 4096×2048 pixels that is four times the pixels of a high definition image, or a desire to distribute a high definition image in an environment of limited transmission capacity such as the Internet has recently increased. Accordingly, in the above-mentioned ITU-T VCEG, an improvement in the coding efficiency is still under discussion.

All pixel sizes of a macroblock being the division unit of an image upon image coding in MPEG1, MPEG2, and ITU-T H.264 and MPEG4-AVC, which are preceding image coding schemes, are 16×16 pixels. On the other hand, according to Non Patent Document 1, proposed as a component technology of a next-generation image coding specification is to extend the numbers of pixels in the horizontal and vertical directions of a macroblock. According to this proposal, the use of macroblocks constructed of 32×32 pixels and 64×64 pixels is also proposed in addition to a pixel size of a macroblock of 16×16 pixels that is specified in MPEG1, MPEG2, ITU-TH.264 and MPEG4-AVC, and the like. This aims to improve the coding efficiency by performing motion compensation and an orthogonal transformation in units of larger regions on a region where much of the motion is the same, as a measure against a prediction that pixel sizes in the horizontal and vertical directions of an image to be coded increases in the future.

FIG. 1 illustrates pixel sizes of blocks to perform a motion compensation process on a macroblock constructed of 32×32 pixels. It is possible to select from performing a motion compensation process at the pixel size of a macroblock, dividing into two in the horizontal and vertical directions to perform a motion compensation process respectively with different motion vectors, and dividing a block into four regions constructed of 16×16 pixels to perform a motion compensation process respectively with different motion vectors.

Moreover, it is also possible to further divide the inside of 16×16 pixels into smaller regions in a division method similar to AVC to perform motion compensation with different motion vectors. According to the above proposal, it is possible to adaptively change the method of dividing a macroblock in accordance with the region of motion.

FIG. 2 illustrates a process order of macroblocks constructed of 16×16 pixels in a progressive scan image (progressive image) in MPEG1, MPEG2, ITU-T H.264 and MPEG4-AVC, and the like. In the cases of these coding schemes, the process is performed in units of 16×16 pixels in raster scan order within a frame.

In contrast, in the case of using the macroblock size of 32×32 pixels or 64×64 pixels that is proposed in Non Patent Document 1, the scan order of blocks of 16×16 pixels of transform coefficients to be units of dequantization and inverse transformation processes changes.

FIG. 3 is a scan order of blocks of 16×16 pixels in the case where a macroblock size of 32×32 pixels is selected. Moreover, if the pixel size of the macroblock of 64×64 pixels is selected, the scan order is as shown in FIG. 4.

### CITATION LIST

### Non-Patent Document

Non Patent Document 1: Peisong Chenn, Yan Ye, Marta Karczewicz, “Video Coding Using Extended Block Sizes”, COM16-C123-E, Qualcomm Inc

### SUMMARY OF THE INVENTION

### Problems to be Solved by the Invention

However, in the case of the proposal described in Non Patent Document 1, the complexity of the macroblock process, and a memory area and a buffer size, which are necessary for the process, may increase since the numbers of pixels in both of the horizontal and vertical directions of a macroblock are increased.

For example, if the macroblock size of 64×64 pixels is selected, a memory area for buffering the equivalent of one macroblock of image data or transform coefficient data needs to be 16 times as large as the case of 16×16 pixels. For example, in the case of the 4:2:0 chrominance format of an 8-bit video signal, if a macroblock size is 16×16 pixels, the buffer size equivalent to one macroblock of pixel data is 384 bytes; however, the case of 64×64 pixels results in 6144 bytes.

In intra-frame prediction (intra-prediction) in MPEG4-AVC, it is also necessary to retain the rightmost one pixel column and the lowest one pixel row among the pixels of the current macroblock at the pixel values in a state before a deblocking filter process is performed, for an intra-frame prediction process for the subsequent macroblock.

The lowest one pixel row of the macroblock needs a buffer equivalent to a pixel size in the horizontal direction of the entire frame regardless of a size in the horizontal direction of the macroblock; however, a register or memory area for holding the rightmost one pixel column of the macroblock is proportional to a pixel size in the vertical direction of the macroblock.

In short, compared with the case where a block size is 16×16 pixels, four times the register or memory area is required for 64×64 pixels.

Moreover, considering executing a deblocking filter process in MPEG4-AVC in units of macroblocks, it is necessary to retain the rightmost four pixel columns and the lowest four pixel rows among the pixels of the current macroblock since there exists the filter process spreading over macroblocks.

A buffer equivalent to the pixel size in the horizontal direction of the entire frame is required to hold data equivalent to the lowest four pixel rows in the macroblock similarly to intra-frame prediction (intra-prediction); however, a register or memory area for holding the rightmost four pixel columns of the macroblock is proportional to the pixel size in the vertical direction of the macroblock.

In short, compared with the case where a macroblock size is 16×16 pixels, four times the register or memory area is required for 64×64 pixels.

As a problem from another viewpoint, if a macroblock size is extended in inter-prediction (inter-frame prediction) in MPEG1, MPEG2, ITU-T H.264/MPEG4-AVC, and the like, the decoding process unit of an image is not in units of 16×16 pixels and therefore the implementation may become complicated.

For example, in the case of transform coefficients in units of 16×16 pixels in MPEG-1, MPEG2, ITU-T H.264/MPEG4-AVC, and the like, the scan order is the raster scan order; however, if pixel sizes in the horizontal and vertical directions of the macroblock are extended, the scan order is the zig-zag scan order as shown in FIGS. 3 and 4, and therefore complicated control such as that the scan order is changed depending on the macroblock size may be required.

The present disclosure has been made considering such circumstances, and an object thereof is to make it possible to improve the coding efficiency more easily by preventing the process order from changing depending on the macroblock size.

### Solutions to Problems

An aspect of the present disclosure is an image processing apparatus including: a region setting unit for setting a size in a vertical direction of a partial region to be a process unit upon coding an image as a fixed value and setting a size in a horizontal direction thereof depending on a value of a parameter of the image; a predicted image generation unit for generating a predicted image using the partial region set by the region setting unit as a process unit; and a coding unit for coding the image by use of a predicted image generated by the predicted image generation unit.

The parameter of the image is a size of the image, and the larger the size of the image is, the larger the region setting unit can set the size in the horizontal direction of the partial region.

The parameter of the image is a bit rate upon coding the image, and the lower the bit rate is, the larger the region setting unit can set the size in the horizontal direction of the partial region.

The parameter of the image is motion of the image, and the smaller the motion of the image is, the larger the region setting unit can set the size in the horizontal direction of the partial region.

The parameter of the image is an area of the same texture in the image, and the larger the area of the same texture is in the image, the larger the region setting unit can set the size in the horizontal direction of the partial region.

The region setting unit can set a size specified in a coding standard as the fixed value.

The coding standard is the AVC (Advanced Video Coding) /H.264 standard, and the region retting unit can set the size in the vertical direction of the partial region to the fixed value of 16 pixels.

It is also possible to further include a number-of-divisions setting unit for setting the number of divisions of the partial region where the size in the horizontal direction is set by the region setting unit.

A feature value extraction unit for extracting a feature value from the image is further included, and the region setting unit can set the size in the horizontal direction of the partial region depending on a value of the parameter included in a feature value of the image, the feature value being extracted by the feature value extraction unit.

The predicted image generation unit can perform inter-frame prediction and motion compensation to generate the predicted image, and the coding unit can code a difference value between the image and the predicted image generated by the predicted image generation unit using the partial region set by the region setting unit as a process unit to generate a bit stream.

The coding unit can transmit the bit stream and information showing the size in the horizontal direction of the partial region set by the region setting unit.

A repeat information generation unit for generating repeat information showing whether the size in the horizontal direction of each partial region of a partial region line being a set of the partial regions lining up in the horizontal direction, the size being set by the region setting unit, is the same as the size in the horizontal direction of each partial region of a partial region line immediately above the partial region line is further included, and the coding unit can transmit the bit stream and the repeat information generated by the repeat information generation unit.

A fixed information generation unit for generating fixed information showing whether the size in the horizontal direction of each partial region of a partial region line being a set of the partial regions lining up in the horizontal direction, the size being set by the region setting unit, is the same as each other is further included, the coding unit can transmit the bit stream and the fixed information generated by the fixed information generation unit.

In addition, an aspect of the present disclosure is an image processing method of an image processing apparatus, and is an image processing method including: a region setting unit setting a size in a vertical direction of a partial region to be a process unit upon coding an image as a fixed value and setting a size in a horizontal direction thereof depending on a value of a parameter of the image; a predicted image generation unit generating a predicted image using the set partial region as a process unit; and a coding unit coding the image by use of the generated predicted image.

Another aspect of the present disclosure is an image processing apparatus including: a decoding unit for decoding a bit stream where an image is coded; a region setting unit for, based on information obtained by the decoding unit, setting a size in a vertical direction of a partial region to be a process unit of the image as a fixed value and setting a size in a horizontal direction thereof depending on a value of a parameter of the image; and a predicted image generation unit for generating a predicted image using the partial region set by the region setting unit as a process unit.

The decoding unit can obtain a difference image between the image and a predicted image generated from the image, the images using the partial region as a process unit, by decoding the bit stream, and the predicted image generation unit can generate the predicted image by performing inter-frame prediction and motion compensation and add the predicted image to the difference image.

The decoding unit can acquire the bit stream and information showing the size in the horizontal direction of the partial region, and the region setting unit can set the size in the horizontal direction of the partial region based on the information.

The decoding unit can acquire the bit stream and repeat information showing whether the size in the horizontal direction of each partial region of a partial region line being a set of the partial regions lining up in the horizontal direction is the same as the size in the horizontal direction of each partial region of a partial region line immediately above the partial region line, and upon the size in the horizontal direction of each partial region being the same in the partial region line and the partial region line immediately above the partial region line, the region setting unit can set the size in the horizontal direction of the partial region to be the same as the size in the horizontal direction of the partial region immediately above based on the repeat information.

The decoding unit can acquire the bit stream and fixed information showing whether the size in the horizontal direction of each partial region of a partial region line being a set of the partial regions lining up in the horizontal direction is the same as each other, and upon the size in the horizontal direction of each partial region of the partial region line being the same as each other, the region setting unit can set the size in the horizontal direction of each partial region of the partial region line to a common value based on the fixed information.

In addition, another aspect of the present disclosure is an image processing method of an image processing apparatus, and is an image processing method including: a decoding unit decoding a bit stream where an image is coded; a region setting unit setting a size in a vertical direction of a partial region to be a process unit of the image as a fixed value and setting a size in a horizontal direction thereof depending on a value of a parameter of the image, based on the obtained information; and a predicted image generation unit generating a predicted image using the set partial region as a process unit.

In an aspect of the present disclosure, a size in a vertical direction of a partial region to be a process unit upon coding an image is set as a fixed value, a size in a horizontal direction thereof is set depending on a value of a parameter of an image, a predicted image is generated using the set partial region as a process unit, and an image is coded by use of the generated predicted image.

In another aspect of the present disclosure, a bit stream where an image is coded is decoded, a size in a vertical direction of a partial region to be a process unit of the image is set as a fixed value based on the obtained information, a size in a horizontal direction thereof is set depending on a value of a parameter of the image, and a predicted image is generated using the set partial region as a process unit.

### Effects of the Invention

According to the present disclosure, it is possible to code image data or decode coded image data. Especially, the coding efficiency can be improved while an increase in the load is suppressed.

### BRIEF DESCRIPTION OF DRAWINGS

FIG. 1 is a view explaining examples of a macroblock.

FIG. 2 is a view explaining an example of a process order of macroblocks of 16×16 pixels.

FIG. 3 is a view explaining an example of a process order of macroblocks of 32×32 pixels.

FIG. 4 is a view explaining an example of a process order of macroblocks of 64×64 pixels.

FIG. 5 is a block diagram illustrating a main configuration example of an image coding apparatus.

FIG. 6 is a view illustrating examples of macroblocks.

FIG. 7 is a view explaining division examples of a macroblock.

FIG. 8 is a view illustrating size change examples of a macroblock.

FIG. 9 is a view illustrating examples of a process order in macroblocks.

FIGS. 10A and 105 are views illustrating more detailed examples of the process order in a macroblock.

FIG. 11 is a block diagram illustrating a detailed configuration example of an image coding apparatus 100.

FIG. 12 is a flowchart explaining an example of the flow of a coding process.

FIG. 13 is a flowchart explaining an example of the flow of a prediction process.

FIG. 14 is a flowchart explaining an example of the flow of an inter motion prediction process.

FIG. 15 is a flowchart explaining an example of the flow of a macroblock setting process.

FIG. 16 is a flowchart explaining an example of the flow of a flag generation process.

FIG. 17 is a block diagram illustrating a main configuration example of an image decoding apparatus.

FIG. 18 is a block diagram illustrating a detailed configuration example of an image decoding apparatus 200.

FIG. 19 is a flowchart explaining an example of the flow of a decoding process.

FIG. 20 is a flowchart explaining an example of the flow of the prediction process.

FIG. 21 is a flowchart explaining an example of the flow of the inter motion prediction process.

FIG. 22 is a flowchart explaining an example of the flow of the macroblock setting process.

FIG. 23 is a block diagram illustrating a main configuration example of a personal computer.

FIG. 24 is a block diagram illustrating a main configuration example of a television receiver.

FIG. 25 is a block diagram illustrating a main configuration example of a mobile phone.

FIG. 26 is a block diagram illustrating a main configuration example of a hard disk recorder.

FIG. 27 is a block diagram illustrating a main configuration example of a camera.

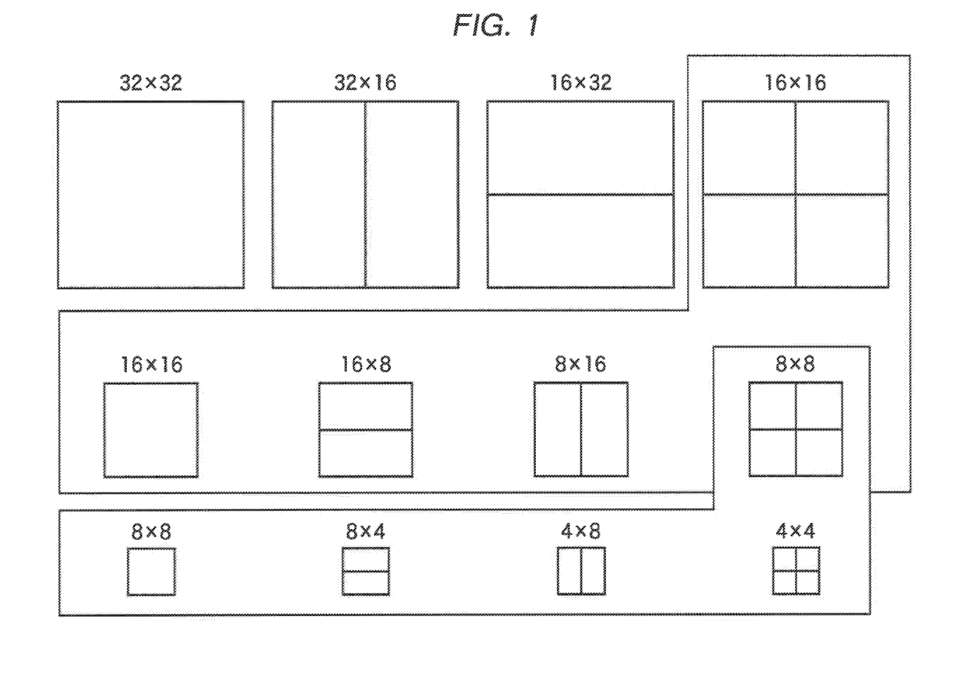

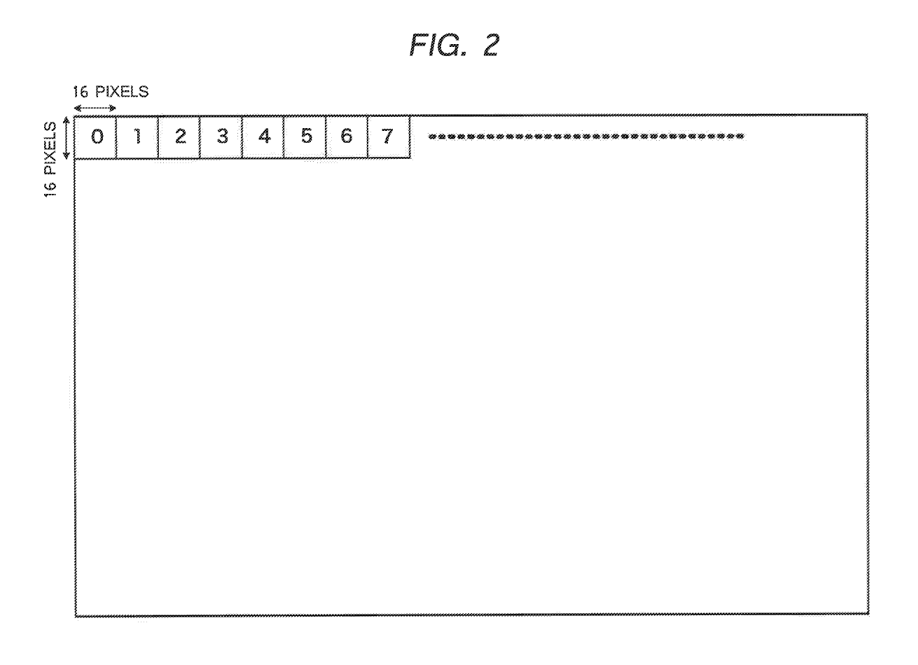

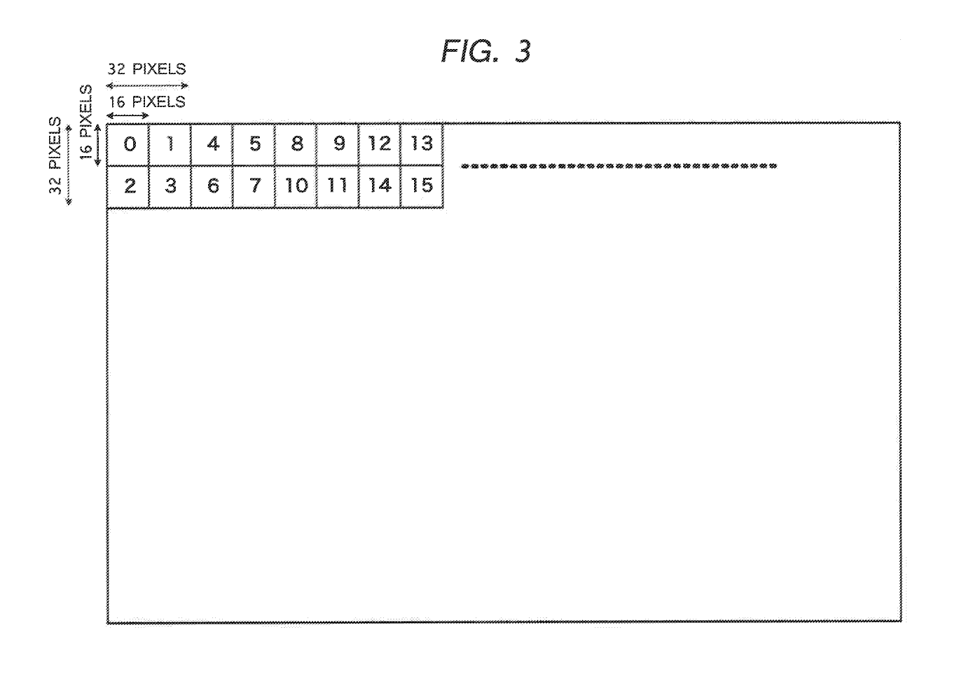

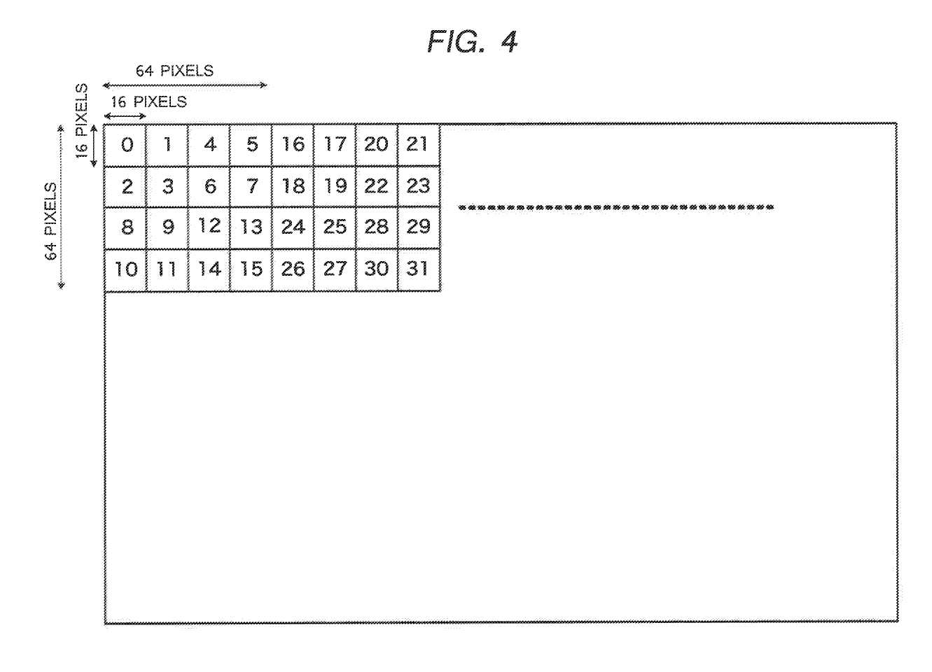

### MODE FOR CARRYING OUT THE INVENTION

A description will hereinafter be given of a mode for carrying out the present technology (hereinafter referred to as embodiment). A description will be given in the following order:

1. First Embodiment (Image coding apparatus),

### 2. Second Embodiment (Image Decoding Apparatus),

### 3. Third Embodiment (Personal Computer),

### 4. Fourth Embodiment (Television Receiver),

### 5. Fifth Embodiment (Mobile Phone),

### 6. Sixth Embodiment (Hard Disk Recorder) and

### 7. Seventh Embodiment (Camera).

### 1. First Embodiment

### Image Coding Apparatus

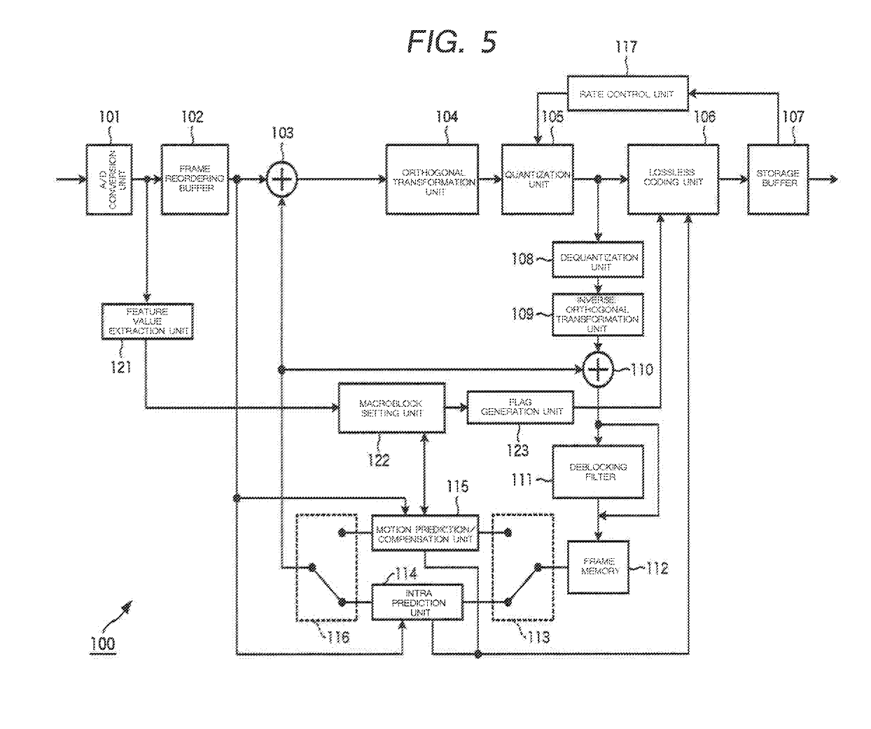

FIG. 5 illustrates a configuration of an embodiment of an image coding apparatus as an image processing apparatus.

An image coding apparatus 100 shown in FIG. 5 is a coding apparatus that compresses and codes an image, for example, in H.264 and MPEG (Moving Picture Experts Group) 4 Part 10 (AVC (Advanced Video Coding)) (hereinafter referred to as H.264/AVC) scheme. However, the image coding apparatus 100 can change a macroblock size by changing a size in a horizontal direction of a macroblock upon performing inter coding. A size in a vertical direction of the macroblock is assumed to be fixed.

In the example of FIG. 5, the image coding apparatus 100 includes an A/D (Analog/Digital) conversion unit 101, a frame reordering buffer 102, a computation unit 103, an orthogonal transformation unit 104, a quantization unit 105, a lossless coding unit 106 and a storage buffer 107. Moreover, the image coding apparatus 100 includes a dequantization unit 108, an inverse orthogonal transformation unit 109, and a computation unit 110. Furthermore, the image coding apparatus 100 includes a deblocking filter 111 and a frame memory 112. Moreover, the image coding apparatus 100 includes a selection unit 113, an intra prediction unit 114, a motion prediction/compensation unit 115 and a selection unit 116. Furthermore, the image coding apparatus 100 includes a rate control unit 117. Moreover, the image coding apparatus 100 includes a feature value extraction unit 121, a macroblock setting unit 122 and a flag generation unit 123.

The A/D conversion unit 101 performs A/D conversion on input image data to output and store the data to and in the frame reordering buffer 102. The frame reordering buffer 102 reorders images of frames stored in the display order in the order of frames for coding in accordance with a GOP (Group of Picture) structure. The frame reordering buffer 102 supplies the images where the order of frames has been reordered to the computation unit 103, the intra prediction unit 114, and the motion prediction/compensation unit 115.

The computation unit 103 subtracts a predicted image supplied from the selection unit 116 from the image read out from the frame reordering buffer 102, and outputs the difference information to the orthogonal transformation unit 104. For example, in the case of an image on which intra coding is performed, the computation unit 103 adds a predicted image supplied from the intra prediction unit 114 to the image read out from the frame reordering unit 102. Moreover, for example, in the case of an image on which inter coding is performed, the computation unit 103 adds a predicted image supplied from the motion prediction/compensation unit 115 to the image read out from the frame reordering buffer 102.

The orthogonal transformation unit 104 performs an orthogonal transformation such as the discrete cosine transform or the Karhunen-Loeve transform on the difference information from the computation unit 103, and supplies the transform coefficients to the quantization unit 105. The quantization unit 105 quantizes the transform coefficients output by the orthogonal transformation unit 104. The quantization unit 105 supplies the quantized transform coefficients to the lossless coding unit 106.

The lossless coding unit 106 performs lossless coding such as variable-length coding or arithmetic coding on the quantized transform coefficients.

The lossless coding unit 106 acquires information showing intra prediction, and the like from the intra prediction unit 114 and acquires information showing an inter prediction mode, and the like from the motion prediction/compensation unit 115. The information showing intra prediction is hereinafter also referred to as the intra prediction mode information. Moreover, the information showing an information mode showing inter prediction (inter-frame prediction) is hereinafter also referred to as the inter prediction mode information.

The lossless coding unit 1106 codes the quantized transform coefficients as well as incorporates (multiplexes) filter coefficients, the intra prediction mode information, the inter prediction mode information, a quantization parameter, and the like into (to) header information of the coded data. The lossless coding unit 106 supplies and stores the coded data obtained by coding to and in the storage buffer 107.

For example, in the lossless coding unit 106, a lossless coding process such as variable-length coding or arithmetic coding is performed. The variable-length coding includes CAVLC (Context-Adaptive Variable Length Coding) specified in H.264/AVC scheme. The arithmetic coding includes CABAC (Context-Adaptive Binary Arithmetic Coding).

The storage buffer 107 temporarily holds the coded data supplied from the lossless coding unit 106 to output as coded image coded in H.264/AVC scheme, for example, to an unillustrated recording apparatus or transmission path in the subsequent stage at a predetermined timing.

Moreover, the transform coefficients quantized in the quantization unit 105 are supplied also to the dequantization unit 108. The dequantization unit 108 dequantizes the quantized transform coefficients in a method corresponding to the quantization by the quantization unit 105 and supplies the obtained transform coefficients to the inverse orthogonal transformation unit 109.

The inverse orthogonal transformation unit 109 performs an inverse orthogonal transformation on the supplied transform coefficients in a method corresponding to the orthogonal transformation process by the orthogonal transformation unit 104. The output on which an inverse orthogonal transformation has been performed is supplied to the computation unit 110.

The computation unit 110 adds the predicted image supplied from the selection unit 116 to the inverse orthogonal transformation result supplied from the inverse orthogonal transformation unit 109, in other words, the reconstructed difference information and obtains the locally decoded image (decoded image). For example, if the difference information corresponds to an image on which intra coding is performed, the computation unit 110 adds the predicted image supplied from the intra prediction unit 114 to the difference information. Moreover, for example, if the difference information corresponds to an image on which inter coding is performed, the computation unit 110 adds the predicted image supplied from the motion prediction/compensation unit 115 to the difference information.

The addition result is supplied to the deblocking filter 111 or the frame memory 112.

The deblocking filter 111 removes the block distortions of the decoded image by appropriately performing a deblocking filter process as well as improves the image quality by appropriately performing a loop filter process by use of the Wiener filter (Wiener Filter), for example. The deblocking filter 111 classes each pixel, and performs an appropriate filter process by class. The deblocking filter 111 supplies the filter process result to the frame memory 112.

The frame memory 112 outputs a stored reference image to the intra prediction unit 114 or the motion prediction/compensation unit 115 via the selection unit 113 at a predetermined timing.

For example, in the case of an image on which intra coding is performed, the frame memory 112 supplies the reference image to the intra predication unit 114 via the selection unit 113. Moreover, for example, in the case of an image on which inter coding is performed, the frame memory 112 supplies the reference image to the motion prediction/compensation unit 115 via the selection unit 113.

in the image coding apparatus 100, for example, an I-picture, a B-picture, and a P-picture from the frame reordering buffer 102 are supplied as images on which intra prediction (also referred to as the infra process) is performed to the intra prediction unit 114. Moreover, the B- and P-pictures read out from the frame reordering buffer 102 are supplied as images on which inter prediction (also referred to as the inter process) is performed to the motion prediction/compensation unit 115.

The selection unit 113 supplies the reference image supplied from the frame memory 112 to the intra prediction unit 114 in the case of an image on which intra coding is performed, and to the motion prediction/compensation unit 115 in the case of an image on which inter coding is performed.

The intra prediction unit 114 performs intra prediction (intra-frame prediction) to generate a predicted image by use of pixel values in the frame. The intra prediction unit 114 performs intra prediction in a plurality of modes (intra prediction modes).

The intra prediction unit 114 generates predicted images in all the intra prediction modes, and evaluates the predicted images to select an optimum mode. The intra prediction unit 114 selects the optimum intra prediction mode, and then supplies the predicted image generated in the optimum mode to the computation unit 103 via the selection unit 116.

Moreover, as described above, the intra prediction unit 114 appropriately supplies information such as the intra prediction mode information showing the adopted intra prediction mode to the lossless coding unit 106.

The motion prediction/compensation unit 115 calculates a motion vector for an image on which inter coding is performed by use of an input image supplied from the frame reordering buffer 102 and a decoded image to serve as a reference frame supplied from the frame memory 112 via the selection unit 113. The motion prediction/compensation unit 115 performs a motion compensation process in accordance with the calculated motion vector to generate a predicted image (inter predication image information).

At this time, the motion prediction compensation unit 115 performs inter prediction by use of a macroblock whose size has been set by the macroblock setting unit 122.

The motion prediction/compensation unit 115 performs an inter prediction process on all the inter prediction modes to be candidates to generate a predicted image. The motion prediction/compensation unit 115 supplies the generated predicted image to the computation unit 103 via the selection unit 116.

Moreover, the motion prediction/compensation unit 115 supplies the inter prediction mode information showing the adopted inter prediction mode and the motion vector information showing the calculated motion vector to the lossless coding unit 106.

The selection unit 116 supplies the output of the intra prediction unit 114 to the computation unit 103 in the case of an image on which intra coding is performed, and the output of the motion prediction/compensation unit 115 to the computation unit 103 in the case of an image on which inter coding is performed.

The rate control unit 117 controls the rate of the quantization operation of the quantization unit 105 based on a compressed image stored in the storage buffer 107 to prevent overflow or underflow from occurring.

The feature value extraction unit 121 extracts the feature values of an image from the digitized image data output from the A/D conversion unit 101. The feature values of an image include, for example, the area of the same texture, an image size, and a bit rate. Naturally, the feature value extraction unit 121 may extract parameters other than these parameters as feature values or may extract only part of the above-mentioned parameters as feature values.

The feature value extraction unit 121 supplies the extracted feature values to the macroblock setting unit 122.

The macroblock setting unit 122 sets a macroblock size based on an image's feature values supplied from the feature value extraction unit 121. Moreover, the macroblock setting unit 122 can set a macroblock size in accordance with the amount of motion of an image supplied from the motion prediction/compensation unit 115, the amount having been detected by the motion prediction/compensation unit 115.

The macroblock setting unit 122 notifies the set macroblock size to the motion prediction/compensation unit 115 and the flag generation unit 123. The motion prediction/compensation unit 115 performs motion prediction compensation at the macroblock size set by the macroblock setting unit 122.

The flag generation unit 123 generates flag information on a macroblock line (an array of macroblocks in the horizontal direction of an image) of the current process target based on the information showing the macroblock size, the information being supplied from the macroblock setting unit 122. For example, the flag generation unit 123 sets a repeat flag and a fixed flag.

The repeat flag is flag information showing that the size of each macroblock of a macroblock line of the current process target is the same as the size of each macroblock of a macroblock line immediately above. Moreover, the fixed flag is flag information showing that the size of each macroblock of a macroblock line of the current process target is all the same.

Naturally, the flag generation unit 123 can generate flag information having an arbitrary content. In short, the flag generation unit 123 may generate flag information other than these. The flag generation unit 123 supplies the lossless coding unit 106 with the generated flag information to add to a code stream.

### [Macroblock]

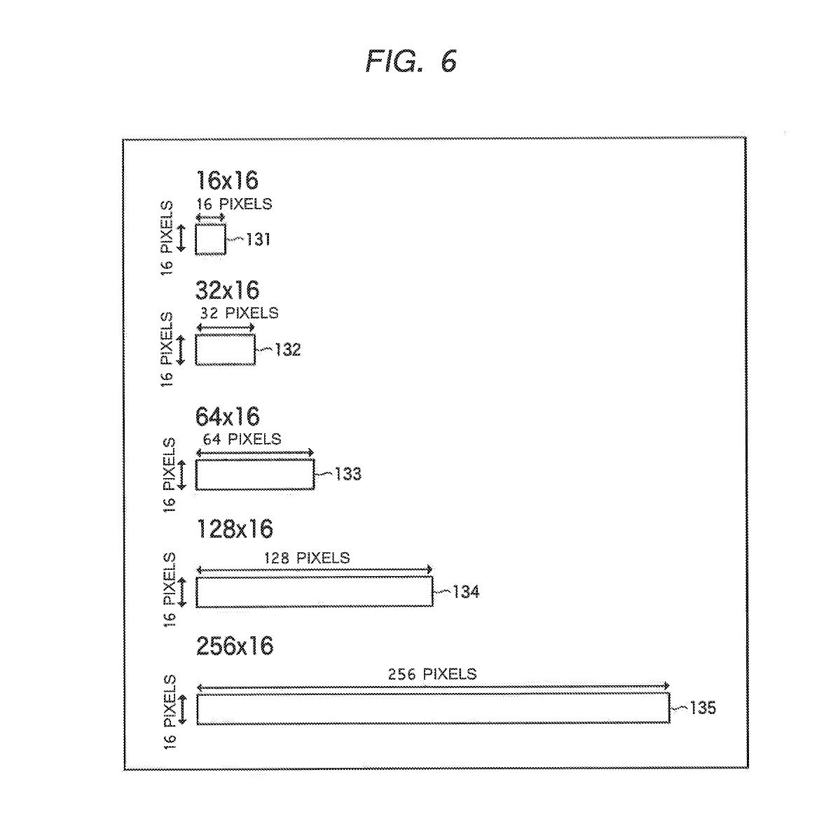

FIG. 6 illustrates examples of macroblock sizes that can be set by the macroblock setting unit 122. The size of a macroblock 131 shown in FIG. 6 is 16×16 pixels. Moreover, the size of a macroblock 132 is 32×16 pixels setting the horizontal direction to the longitudinal direction. Furthermore, the size of a macroblock 133 is 64×16 pixels setting the horizontal direction to the longitudinal direction. Moreover, the size of a macroblock 134 is 128×16 pixels setting the horizontal direction to the longitudinal direction. Furthermore, the size of a macroblock 135 is 256×16 pixels setting the horizontal direction to the longitudinal direction.

The macroblock setting unit 122 selects one optimum size, for example, from these sizes as the size of a macroblock targeted for an inter prediction process performed in the motion prediction/compensation unit 115. Naturally, a macroblock size set by the macroblock setting unit 122 is arbitrary, and may be a size other than those shown in FIG. 6.

However, the macroblock setting unit 122 does not change the size in the vertical direction of a macroblock (fixes the size to a predetermined size) as shown in FIG. 6. In short, if a macroblock size is increased, the macroblock setting unit 122 extends the size in the horizontal direction.

In this manner, the macroblock setting unit 122 sets the size in the vertical direction of a macroblock to a fixed value to obtain effects to be described below.

Firstly, since a macroblock size can be changed, it is possible to select an appropriate size depending on various parameters such as the content of an image (including the area of the same texture and the location of an edge), an image size, the amount of motion of an image, and a bit rate and to improve the coding efficiency compared with the case where a macroblock size is fixed.

Next, even if the macroblock setting unit 122 increases a macroblock size, it is possible to suppress an increase in the amount of data that needs to be held as adjacent pixels in intra prediction. For example, the rightmost one pixel column of a macroblock needs to be stored as adjacent pixels in intra prediction; however, in this case, even if the macroblock size is changed, the size in the vertical direction of the macroblock is constant and therefore the number of pixels at the rightmost one pixel column of the macroblock is constant and the amount of data is substantially unchanged.

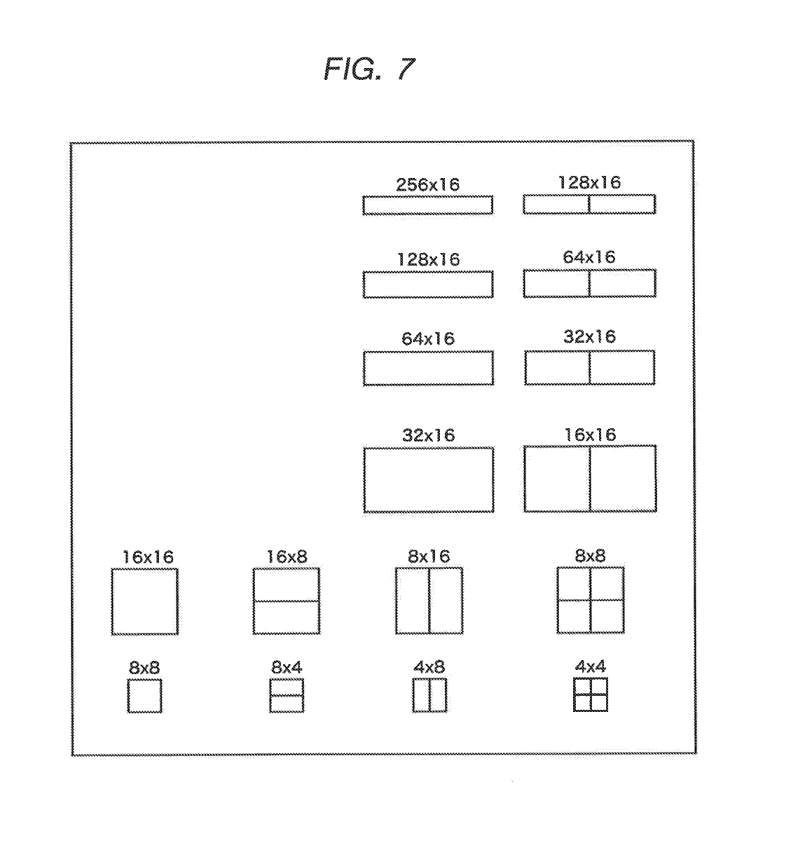

Moreover, it is possible to suppress the complexity of the division of a macroblock. FIG. 7 illustrates a method for dividing the macroblocks shown in FIG. 6. If the pixel size in the horizontal direction of a macroblock is equal to or more than 32 pixels, it is possible to select from, in a macroblock of each pixel size, performing a motion compensation process at the same pixel size as that of the macroblock, and performing a motion compensation process at a size dividing the horizontal pixel size into two. If the divided block size for a motion compensation process is equal to or more than 32 pixels, it is possible to further perform a motion compensation process on each block at the size dividing the horizontal pixel size into two. If the pixel size in the horizontal direction of a macroblock or the size in the horizontal direction of the divided block is 16 pixels, the subsequent division is assumed to be the same as the division method specified in ITU-T H.264 and MPEG4-AVC as shown in FIG. 7.

In this manner, if a macroblock size is equal to or less than 16×16 pixels, it is possible to divide a macroblock in a conventional method, and if a macroblock size is larger than 15×16 pixels, it is possible to divide a macroblock into only two of the left and right. In short, it becomes easier to divide a macroblock than the case of a conventional extended macroblock.

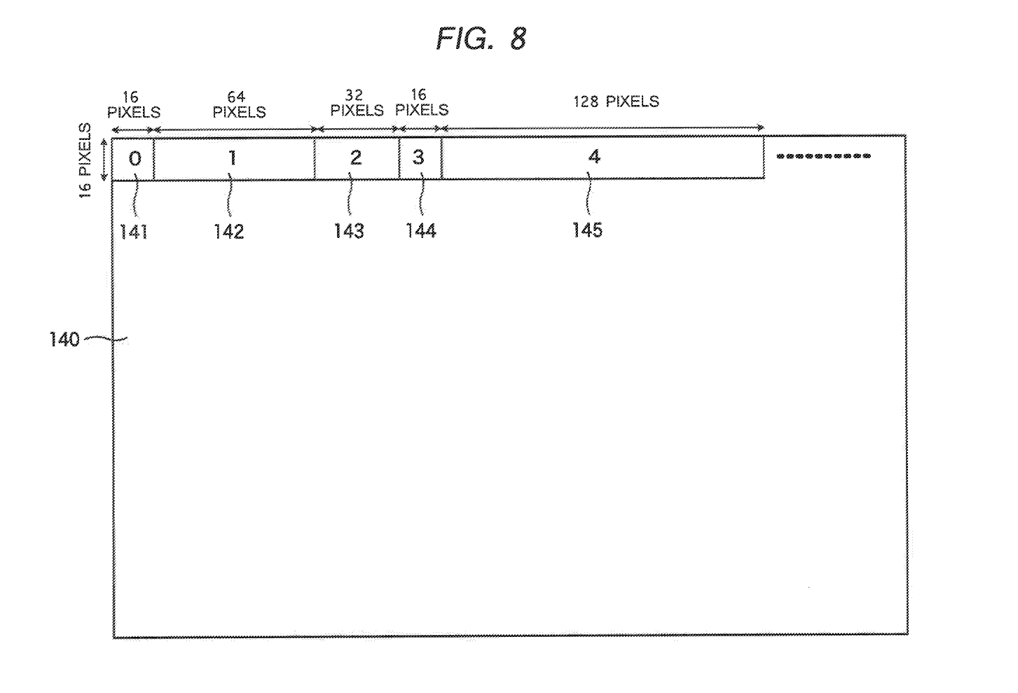

Furthermore, for example, as shown in FIG. 8, it is possible to adaptively switch macroblock sizes in the horizontal direction in a frame between 16 pixels, 32 pixels, 64 pixels, 128 pixels and 256 pixels. Since the sizes in the vertical direction of macroblocks are fixed, it becomes possible to arbitrarily change the sizes (in the horizontal direction) of macroblocks on the same macroblock line as in macroblocks 141 to 145 shown in FIG. 8. Therefore, it is possible to further improve the coding efficiency compared with the case of the known extended macroblock.

In this manner, it is possible to arbitrarily change a macroblock size, and therefore it is also possible to omit the division of each macroblock. In this case, one motion vector is allocated to each macroblock. As in the macroblock 141, a macroblock whose size in the horizontal direction is 16 pixels may be divided similarly to the division method specified in ITU-T H.264 and MPEG4-AVC.

In human vision, there is a characteristic that the sensitivity to a change in the vertical direction is high and the sensitivity to a change in the horizontal direction is low. Therefore, as in the example of FIG. 8, the sizes in the vertical direction of macroblocks are all the same, and only the sizes in the horizontal direction are changed and accordingly it is possible to reduce visual influence given by a change in a macroblock size in a frame.

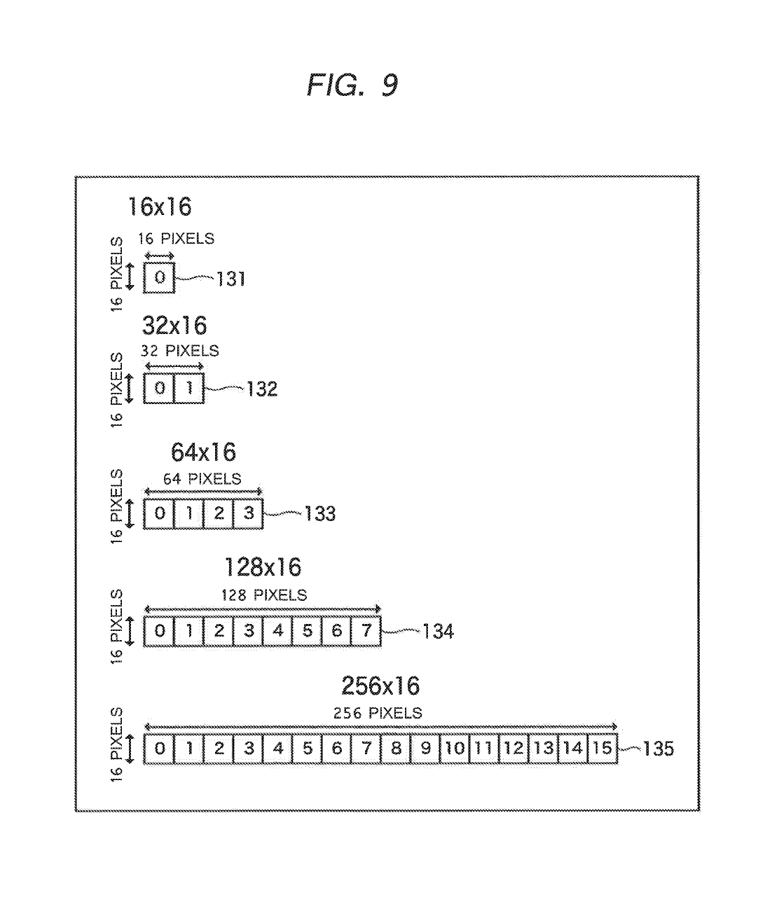

Moreover, since the size in the vertical direction is fixed, there is no need to change the scan order depending on the macroblock size, and the control is easy. FIG. 9 illustrates examples of the scan order at the macroblock sizes of FIG. 6.

As shown in FIG. 9, the process proceeds in raster scan order in units of 16×16 pixels at any sizes of the macroblocks 131 to 135. The squares shown in FIG. 9 each indicate 16×16 pixels and internal numbers thereof represent the process orders.

In this manner, even if a macroblock size is increased, the process simply proceeds from the left to the right in units of 16×16 pixels and therefore the process order is similar to the case where the process moves to an adjacent macroblock. In short, the procedure is the same regardless of the macroblock size and accordingly the control becomes easy.

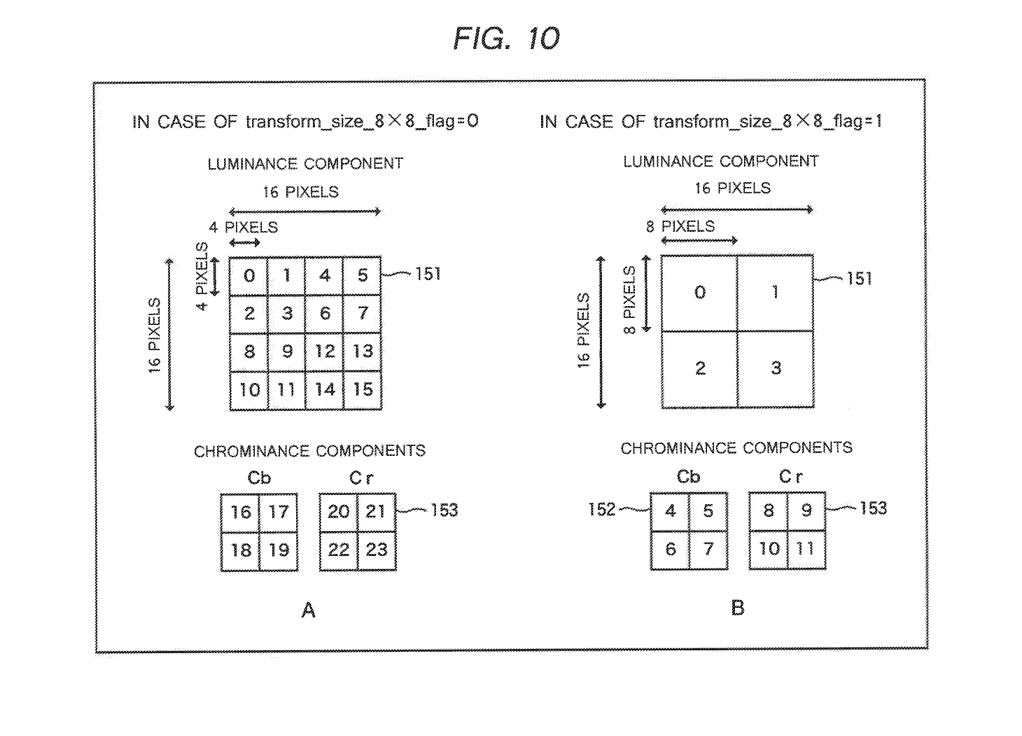

The block division and decoding order of transform coefficients in 16×16 pixels are as specified in ITU-T H.264 and MPEG4-AVC. FIGS. 10A and 10B illustrate the block division of transform coefficients in 16×16 pixels specified in ITU-T H.264 and MPEG4-AVC in 4:2:0 chrominance format and the process order of each divided region.

For example, if a luminance component is coded in units of 4×4 pixels, a 4×4 region of a macroblock 151 of a luminance component Y, a 2×2 region of a macroblock 152 of a chrominance component Cb, and a 2×2 region of a macroblock 153 of a chrominance component Cr are processed in numerical order shown in FIG. 10A.

Moreover, for example, if a luminance component is coded in units of 8×8 pixels, a 2×2 region of the macroblock 151 of the luminance component Y, a 2×2 region of the macroblock 152 of the chrominance component Cb, and a 2×2 region of the macroblock 153 of the chrominance component Cr are processed in numerical order shown in FIG. 10B.

It is sufficient if a size in the vertical direction of a macroblock is fixed, and a size thereof is arbitrary. However, as described above, a size in the vertical direction of a macroblock is set to 16 pixels; accordingly it is possible to improve an affinity with an existing coding standard (for example, ITU-T H.264 and MPEG4-AVC or MPEG2).

For example, in a coding standard such as ITU-T H.264 and MPEG4-AVC or MPEG2, 16×16 pixels is specified as a block size. A size (for example, 16 pixels) in the vertical direction of a block size specified in such an existing coding standard is used as the size in the vertical direction of a macroblock, and accordingly it is possible to perform, for example, the process of 16×16 pixels or lower as specified in the coding standard as described above. An affinity with the existing coding standard is improved in this manner, and accordingly, it is possible not only to improve compatibility with the coding standard but also to make development easy.

### [Details of Image Coding Apparatus]

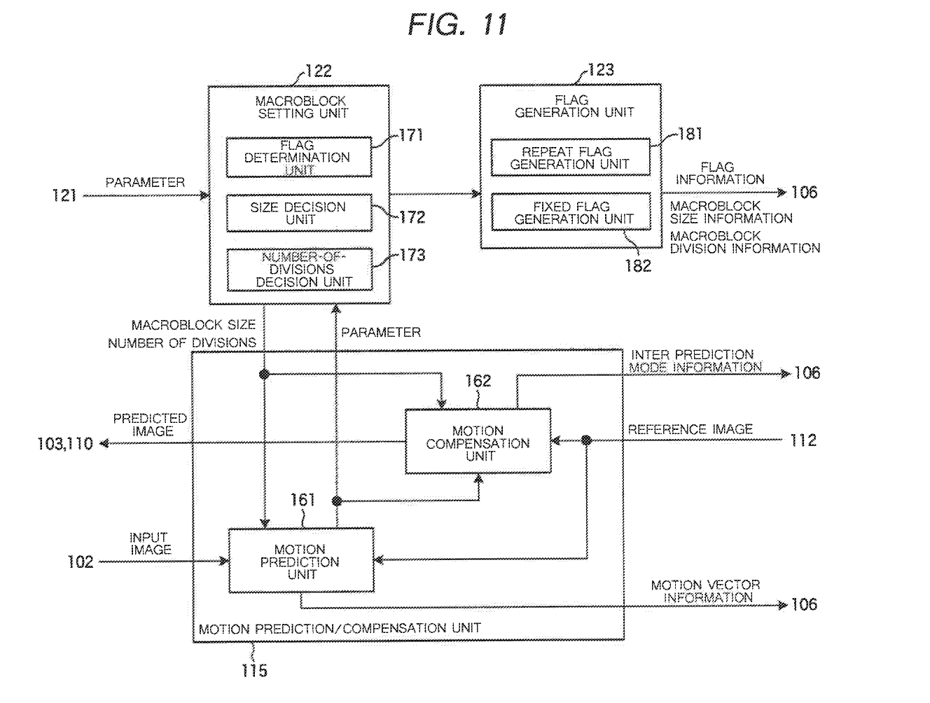

FIG. 11 is a block diagram illustrating configuration examples of the motion prediction/compensation unit 115, the macroblock setting unit 122, and the flag generation unit 123 in the image coding apparatus 100 of FIG. 5

As shown in FIG. 11, the motion prediction/compensation unit 115 includes a motion prediction unit 161 and a motion compensation unit 162.

The motion prediction unit 161 performs motion detection by the macroblock size and the number of divisions, which have been set by the macroblock setting unit 122, by use of the input image supplied from the frame reordering buffer 102 and the reference image supplied from the frame memory 112. The motion prediction unit 161 feeds back a parameter such as a motion vector. The macroblock setting unit 122 sets a macroblock size and the number of divisions based on the fed back parameter, the parameters supplied from the feature value extraction unit 121, and the like, and give notification to the motion prediction unit 161 and the motion compensation unit 162. The motion prediction unit 161 performs motion detection with the settings to generate motion vector information. The motion prediction unit 161 supplies the motion vector information to the motion compensation unit 162 and the lossless coding unit 106.

The motion compensation unit 162 performs motion compensation by the macroblock size and the number of divisions, which have been set by the macroblock setting unit 122, by use of the motion vector information supplied from the motion prediction unit 161 and the reference image supplied from the frame memory 112 to generate a predicted image.

The motion compensation unit 162 supplies the predicted image to the computation unit 103 and the computation unit 110 via the selection unit 116. Moreover, the motion compensation unit 162 supplies the inter prediction mode information to the lossless coding unit 106.

The macroblock setting unit 122 includes a parameter determination unit 171, a size decision unit 172, and a number-of-divisions decision unit 173.

The parameter determination unit 171 determines the parameters supplied from the feature value extraction unit 121, the motion prediction unit 161, and the like. The size decision unit 172 decides a size in the horizontal direction of a macroblock (a size in the vertical direction is a fixed value) based on the determination result of the parameters by the parameter determination unit 171. The number-of-divisions decision unit 173 decides the number of divisions of a macroblock depending on the determination result of the parameters by the parameter determination unit 171 and the macroblock size.

The macroblock setting unit 122 supplies to the motion prediction unit 161 the macroblock size information showing the macroblock size and the macroblock division information showing the number of divisions, which have been determined in this manner. Moreover, the macroblock setting unit 122 supplies the macroblock size information and the macroblock division information also to the flag generation unit 123.

The flag generation unit 123 includes a repeat flag generation unit 181 and a fixed flag generation unit 182. The repeat flag generation unit 181 sets the repeat flag by use of the macroblock size information and the macroblock division information, which are supplied from the macroblock setting unit 122, as necessary. In short, the repeat flag generation unit 181 sets the repeat flag if the configurations of a macroblock size (that may include the number of divisions) are the same in a macroblock line of a current process target and a macroblock line immediately above.

The fixed flag generation unit 182 sets the fixed flag by use of the macroblock size information and the macroblock division information, which have been supplied from the macroblock setting unit 122, as necessary. In short, the fixed flag generation unit 182 sets the fixed flag if the sizes of all macroblocks of a macroblock line of a current process target (that may include the number of divisions) are the same as each other.

The flag generation unit 123 generates these pieces of flag information to supply these pieces of flag information together with the macroblock size information and the macroblock division information to the lossless coding unit 106. The lossless coding unit 106 adds to a code stream these pieces of flag information as well as the macroblock size information and the macroblock division information. In short, these pieces of flag information are supplied to the decoding side.

### [Coding Process]

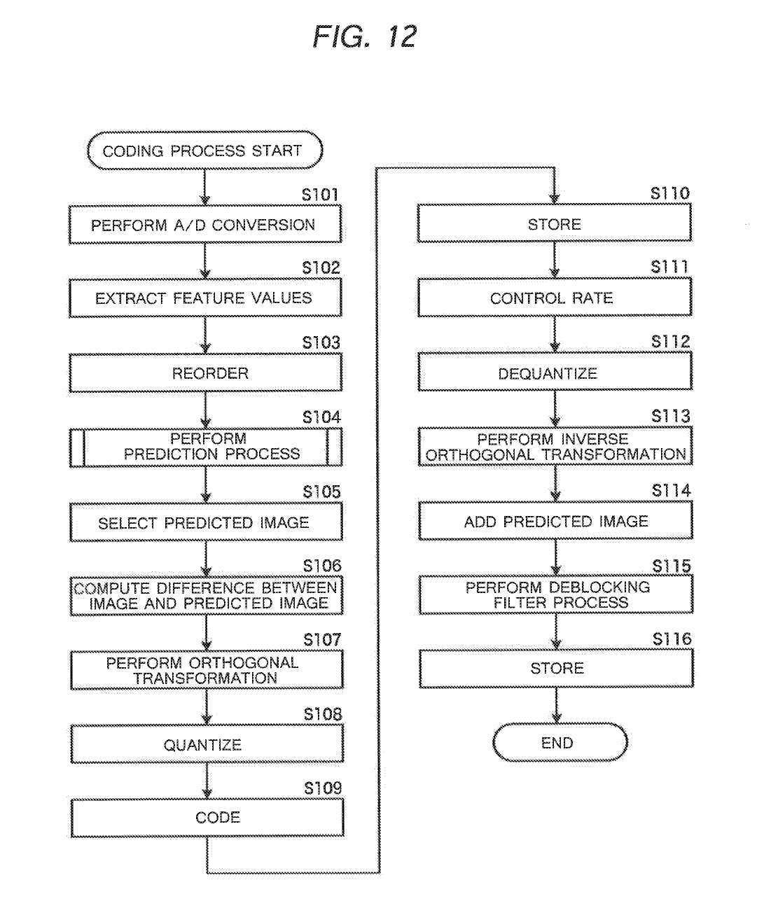

Next, a description will be given of the flow of each process executed by the image coding apparatus 100 described above. Firstly, a description will be given of an example of the flow of a coding process with reference to the flowchart of FIG. 12.

In Step S101, the A/D conversion unit 101 performs A/D conversion on an input image. In Step S102, the feature value extraction unit 121 extracts feature values from the input image on which A/D conversion has been performed. In Step S103, the frame reordering buffer 102 stores the images supplied from the A/D conversion unit 101 and performs reordering from the order of displaying pictures to the order of coding.

In Step S104, the intra prediction unit 114 and the motion prediction/compensation unit 115 performs a prediction process on the image, respectively. In other words, in Step S104, the intra prediction unit 114 performs an intra prediction process in intra prediction mode. The motion prediction/compensation unit 115 performs a motion prediction compensation process in inter prediction mode.

In Step S105, the selection unit 116 decides an optimum prediction mode based on cost functions values output from the intra prediction unit 114 and the motion prediction/compensation unit 115. In short, the selection unit 116 selects one of a predicted image generated by the intra prediction unit 114 and a predicted image generated by the motion prediction/compensation unit 115.

Moreover, the selection information of the predicted image is supplied to the intra prediction unit 114 or the motion prediction/compensation unit 115. If the predicted image in optimum intra prediction mode is selected, the intra prediction unit 114 supplies the information showing the optimum intra prediction mode (that is, the intra prediction mode information) to the lossless coding unit 106.

If the predicted image in optimum inter prediction mode is selected, the motion prediction/compensation unit 115 outputs to the lossless coding unit 106 the information showing the optimum inter prediction mode, and as necessary, information corresponding to the optimum inter prediction mode. The information corresponding to the optimum inter prediction mode includes motion vector information, flag information and reference frame information.

Moreover, in this case, the flag generation unit 123 appropriately supplies to the lossless coding unit 106 the flag information, the macroblock size information, the macroblock division information, and the like.

In Step S106, the computation unit 103 computes the difference between the image reordered in Step S103 and the predicted image obtained by the prediction process in Step S104. The predicted image is supplied from the motion prediction/compensation unit 115 in the case of inter prediction, and from the intra prediction unit 114 in the case of intra prediction, respectively to the computation unit 103 via the selection unit 116.

The difference data are reduced in the amount of data compared with the original image data. Therefore, it is possible to compress the amount of data compared with the case of coding an image as it is.

In Step S107, the orthogonal transformation unit 104 performs an orthogonal transformation on the difference information supplied from the computation unit 103. Specifically, an orthogonal transformation such as the discrete cosine transform or the Karhunen-Loeve transform is performed to output transform coefficients. In Step S108, the quantization unit 105 quantizes the transform coefficients.

In Step S109, the lossless coding unit 106 codes the quantized transform coefficients output from the quantization unit 105. In other words, lossless coding such as variable-length coding or arithmetic coding is performed on the difference image (the second difference image in the case of inter).

The lossless coding unit 106 codes the information related to the prediction mode of the predicted image selected in the process of Step S105 and adds the information to the header information of coded data obtained by coding the difference image.

In short, the lossless coding unit 106 codes the intra prediction mode information supplied from the intra prediction unit 114, the information corresponding to the optimum inter prediction mode supplied from the motion prediction/compensation unit 115, or the like for addition to the header information. Moreover, the lossless coding unit 106 adds also various information supplied from the flag generation unit 123 to the header information of the coded data, and the like.

In Step S110, the storage buffer 107 stores the coded data output from the lossless coding unit 106. The coded data stored in the storage buffer 107 is appropriately read out to be transmitted to the decoding side via a transmission path.

In Step S111, the rate control unit 117 controls the rate of the quantization operation of the quantization unit 105 based on the compressed image stored in the storage buffer 107 to prevent overflow or underflow from occurring.

Moreover, the differece information quantized by the process of Step S108 is locally decoded as shown below. In other words, in Step S112, the dequantization unit 108 dequantizes the transform coefficients quantized by the quantization unit 105 with a characteristic corresponding to the characteristic of the quantization unit 105. In Step S113, the inverse orthogonal transformation unit 109 performs an inverse orthogonal transformation on the transform coefficients dequantized by the dequantization unit 108 with a characteristic corresponding to the characteristic of the orthogonal transformation unit 104.

In Step S114, the computation unit 110 adds the predicted image input via the selection unit 116 to the locally decoded difference information to generate a locally decoded image (an image corresponding to the input into the computation unit 103). In Step S115, the deblocking filter 111 filters the image output from the computation unit 110. Accordingly, the block distortions are removed. In Step S116, the frame memory 112 stores the filtered image. An image on which the filter process is not performed by the deblocking filter 111 is also supplied to the frame memory 112 from the computation unit 110 and is stored therein.

### [Prediction Process]

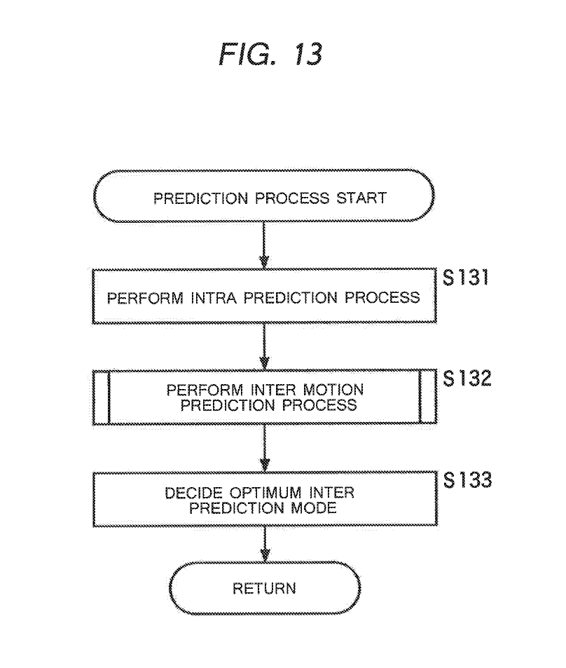

Next, a description will be given of an example of the flow of the prediction process executed in Step S104 of FIG. 12 with reference to the flowchart of FIG. 13.

In Step S131, the intra prediction unit 114 performs intra prediction on the pixels of a block of a process target in all the intra prediction modes to be candidates.

If the image of the process target, which is supplied from the frame reordering buffer 102, is an image on which the inter process is performed, an image to be referred to is read out from the frame memory 112 to be supplied to the motion prediction/compensation unit 115 via the selection unit 113. In Step S132, the motion prediction/compensation unit 115 performs an inter motion prediction process based on these images. In other words, the motion prediction/compensation unit 115 refers to the image supplied from the frame memory 112 to perform a motion prediction process in all the inter prediction modes to be candidates.

In Step S133, the motion prediction/compensation unit 115 decides a prediction mode that gives a minimum value as the optimum inter prediction mode from the cost function values for the inter prediction modes calculated in Step S132. The motion prediction/compensation unit 115 then supplies to the selection unit 116 the difference between the image on which the inter process is performed and the second difference information generated in the optimum inter prediction mode, and the cost function value in the optimum inter prediction mode.

### [Inter Motion Prediction Process]

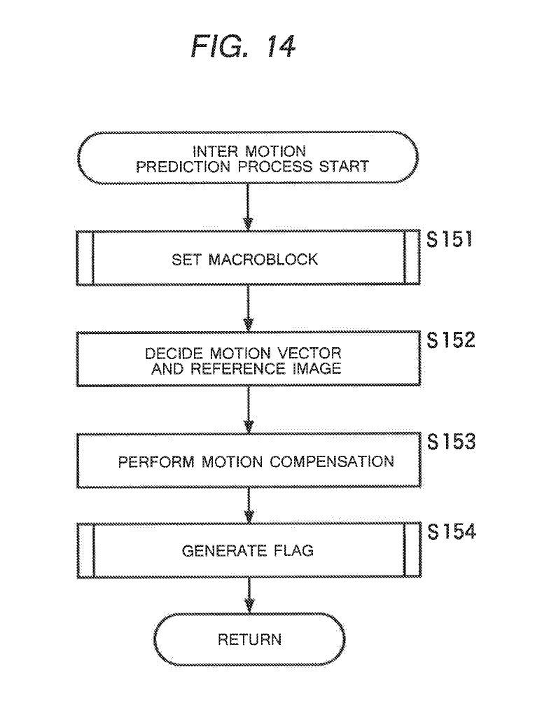

FIG. 14 is a flowchart explaining an example of the flow of the inter motion prediction process executed in Step S132 of FIG. 13.

If the inter motion prediction process starts, the macroblock setting unit 122 sets a size in the horizontal direction of and the number of divisions of a macroblock, and the like in Step S151. In Step S152, the motion prediction/compensation unit 115 decides a motion vector and a reference image. In Step S153, the motion prediction/compensation unit 115 performs motion compensation. In Step S154, the flag generation unit 123 generates a flag. If the process of Step S154 ends, the image coding apparatus 100 returns the process to Step S132 of FIG. 13, and advances the process to Step S133.

### [Macroblock Setting Process]

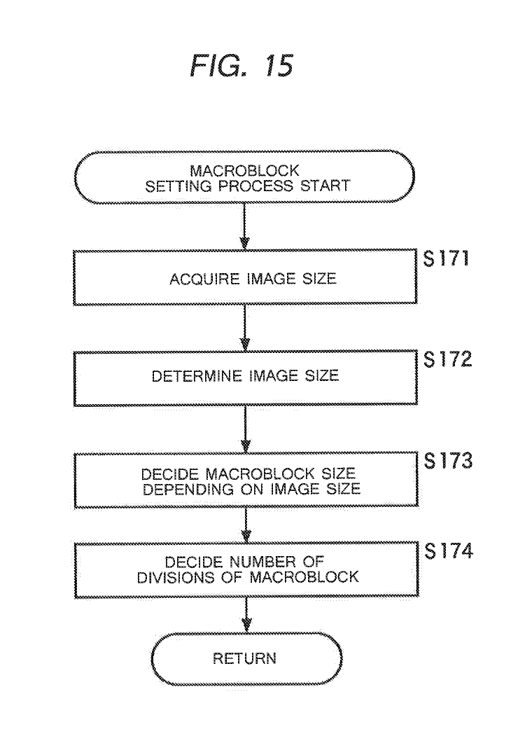

Next, a description will be given of an example of the flow of the macroblock setting process executed in Step S151 of FIG. 14 with reference to the flowchart of FIG. 15.

If the macroblock setting process starts, the macroblock setting unit 122 acquires the image size of the input image in Step S171. In Step S172, the parameter determination unit 171 determines the image size.

In Step S173, the size decision unit 172 decides a size in the horizontal direction of a macroblock depending on the determined image size. Moreover, the number-of-divisions decision unit 173 decides the number of divisions of a macroblock in Step S174.

If the process of Step S174 ends, the macroblock setting unit 122 returns the process to Step S151 of FIG. 14, and advances the process to Step S152.

The description has been given in the above that the image size of an input image is used as a parameter for determining a size in the horizontal direction of and the number of divisions of a macroblock; however, the parameter is arbitrary, and, as described above, may be for example, the content of an image, the amount of motion, a bit rate or the like, or may be other than these. Moreover, a plurality of parameters may be used for a decision.

### [Flag Generation Process]

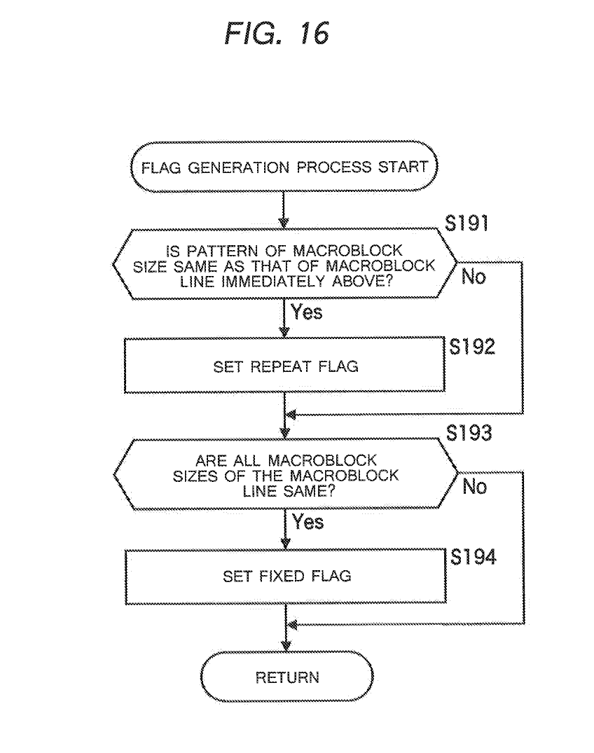

Next, a description will be given of an example of the flow of the flag generation process executed in Step S154 of FIG. 14 with reference to the flowchart of FIG. 16.

If the flag generation process starts, the repeat flag generation unit 161 determines in Step S191 whether or not the pattern of the macroblock size is the same as that of a macroblock line immediately above.

If it is determined to be the same, the repeat flag generation unit 181 advances the process to Step S192, sets the repeat flag, and advances the process to Step S193. If it is determined not to be the same in Step S191, the repeat flag generation unit 181 advances the process to Step S193.

In Step S193, the fixed flag generation unit 182 determines whether or not all macroblock sizes of the macroblock line are the same.

If they are determined to be the same, the fixed flag generation unit 182 advances the process to Step S194, sets the fixed flag, ends the flag generation process, returns the process to Step S154 of FIG. 14, further ends the inter motion prediction process, returns the process to Step S132 of FIG. 13, and advances the process to Step S133.

Moreover, if they are determined not to be the same in Step S193, the fixed flag generation unit 182 ends the flag generation process, returns the process to Step S154 of FIG. 14, further ends the inter motion prediction process, returns the process to Step S132 of FIG. 13, and advances the process to Step S133.

As described above, only a size in the horizontal direction of a macroblock is made variable and accordingly the image coding apparatus 100 can further improve the coding efficiency while suppressing an increase in the load.

Moreover, the flag information on a macroblock size is transmitted as described above and accordingly, as will be described later, it makes it possible to set a macroblock size on the decoding side more easily.

The size of each block, which has been described above, is an example, and may be a size other than the above-mentioned sizes. Moreover, in the above, the description has been given of the method for transmitting the macroblock size information, the macroblock division information, the flag information, and the like to the decoding side, where the lossless coding unit 106 multiplexes these pieces of information to the header information of the coded data; however, the storage location of these pieces of information is arbitrary. For example, the lossless coding unit 106 may describe these pieces of information in a bit stream as syntax. Moreover, the lossless coding unit 106 may store these pieces of information in a predetermined region as supplementary information for transmission. For example, these pieces of information may be stored in a parameter set (for example, the header of a sequence or picture) such as SEI (Suplemental Enhancement Information).

Moreover, the lossless coding unit 106 may transmit these pieces of information apart from the coded data (as another file) from an image coding apparatus to an image decoding apparatus. In this case, it is necessary to make the corresponding relationship between these pieces of information and the coded data clear (make it possible to understand on the decoding side); however, a method thereof is arbitrary. For example, table information showing the corresponding relationship may be generated separately, or link information showing data of the counterpart may be embedded in the mutual data.

### 2. Second Embodiment

### Image Decoding Apparatus

The coded data coded by the image coding apparatus 100 described in the first embodiment is transmitted to an image decoding apparatus corresponding to the image coding apparatus 100 via a predetermined transmission path to be decoded.

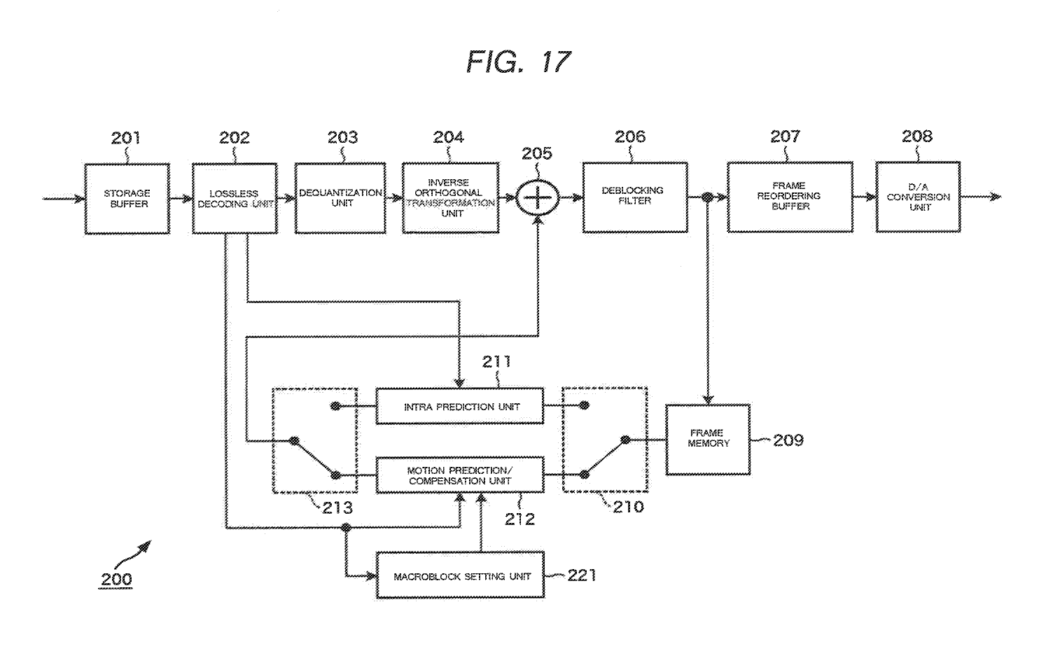

A description will hereinafter be given of the image decoding apparatus. FIG. 17 is a block diagram illustrating a main configuration example of the image decoding apparatus.

As shown in FIG. 17, an image decoding apparatus 200 includes a storage buffer 201, a lossless decoding unit 202, a dequantization unit 203, an inverse orthogonal transformation unit 204, a computation unit 205, a deblocking filter 206, a frame reordering buffer 207, and a D/A conversion unit 208. Moreover, the image decoding apparatus 200 includes a frame memory 209, a selection unit 210, an intra prediction unit 211, a motion prediction/compensation unit 212, and a selection unit 213. Furthermore, the image decoding apparatus 200 includes a macroblock setting unit 221.

The storage buffer 201 stores the transmitted coded data. The coded data has been coded by the image coding apparatus 100. The lossless decoding unit 202 decodes the coded data read out from the storage buffer 201 at a predetermined timing in a scheme corresponding to the coding scheme of the lossless coding unit 106 of FIG. 5.

The dequantization unit 203 dequantizes coefficient data obtained by being decoded by the lossless decoding unit 202 in a scheme corresponding to the quantization scheme of the quantization unit 105 of FIG. 5. The dequantization unit 203 supplies the dequantized coefficient data to the inverse orthogonal transformation unit 204. The inverse orthogonal transformation unit 204 performs an inverse orthogonal transformation on the coefficient data in a scheme corresponding to the orthogonal transformation scheme of the orthogonal transformation unit 104 of FIG. 5 to obtain decoded residual data corresponding to residual data before an orthogonal transformation was performed thereon in the image coding apparatus 100.

The decoded residual data obtained by the inverse orthogonal transformation being performed thereon is supplied to the computation unit 205. Moreover, the computation unit 205 is supplied with a predicted image from the intra prediction unit 211 or the motion prediction/compensation unit 212 via the selection unit 213.

The computation unit 205 adds the decoded residual data to the predicted image and obtains decoded image data corresponding to image data before the predicted image was subtracted by the computation unit 103 of the image coding apparatus 100. The computation unit 205 supplies the decoded image data to the deblocking filter 206.

The deblocking filter 206 removes the block distortions of the decoded images to supply the images to the frame memory 209 for storage and supply also to the frame reordering buffer 207.

The frame reordering buffer 207 reorders the images. In other words, the order of frames reordered in the coding order by the frame reordering buffer 102 of FIG. 5 is reordered in the original display order. The D/A conversion unit 206 performs D/A conversion on the image supplied from the frame reordering buffer 207 to output and display the image to and on an unillustrated display.

The selection unit 210 reads out an image on which the inter process is performed and an image to be referred to from the frame memory 209 to supply to the motion prediction/compensation unit 212. Moreover, the selection unit 210 reads out an image to be used for intra prediction from the frame memory 209 to supply to the intra prediction unit 211.

The intra prediction unit 211 is appropriately supplied by the lossless decoding unit 202 with information showing the intra prediction mode, the information being obtained by decoding the header information, and the like. The intra prediction unit 211 generates a predicted image based on the information and supplies the generated predicted image to the selection unit 213.

The motion prediction/compensation unit 212 acquires from the lossless decoding unit 202 the information (the prediction mode information, the motion vector information, the reference frame information) obtained by decoding the header information. Moreover, the macroblock setting unit 221 gives the motion prediction/compensation unit 212 the specifications of a macroblock size and the number of divisions. If being supplied with the information showing the inter prediction mode, the motion prediction/compensation unit 212 generates a predicted image based on the information supplied from the lossless decoding unit 202 and the macroblock setting unit 221 and supplies the generated predicted image to the selection unit 213.

The selection unit 213 selects the predicted image generated by the motion prediction/compensation unit 212 or the intra prediction unit 211 to supply to the computation unit 205.

The lossless decoding unit 202 supplies the macroblock setting unit 221 with various information such as the flag information, the macroblock size information, and the macroblock division information, which are added to the code stream.

The macroblock setting unit 221 sets a macroblock size and its number of divisions based on the information supplied from the lossless decoding unit 202, which has been supplied from the image coding apparatus 100, and supplies the settings to the motion prediction/compensation unit 212.

### [Details of Image Decoding Apparatus]

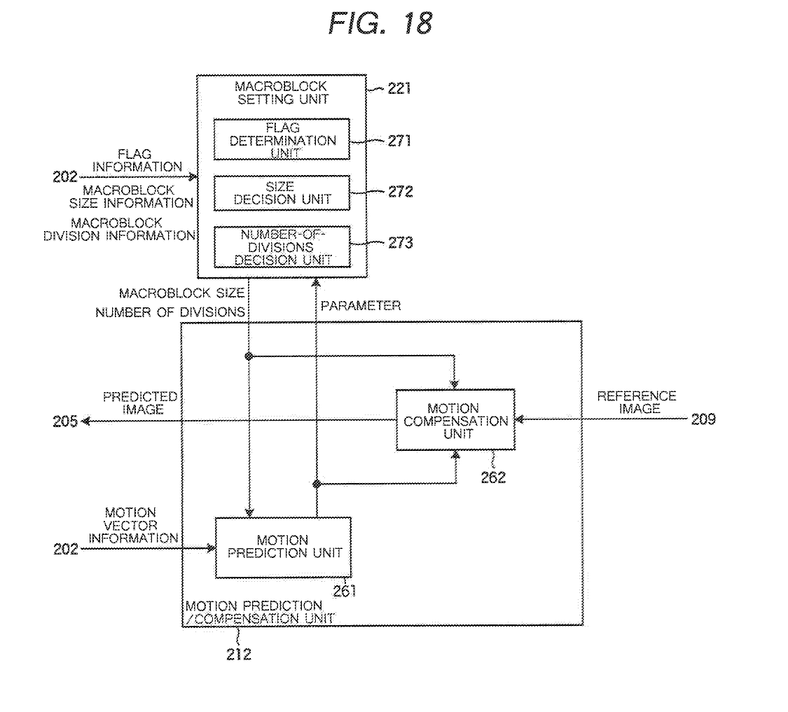

FIG. 18 is a block diagram illustrating configuration examples of the motion prediction/compensation unit 212 and the macroblock setting unit 221 in the image decoding apparatus 200 of FIG. 17.

As shown in FIG. 18, the motion prediction/compensation unit 212 includes a motion prediction unit 261 and a motion compensation unit 262.

The motion prediction unit 261 basically has a similar configuration to and performs a similar process to those of the motion prediction unit 161 (FIG. 11) of the image coding apparatus 100. The motion compensation unit 262 basically has a similar configuration to and performs a similar process to those of the motion compensation unit 162 of the image coding apparatus 100.

Moreover, the macroblock setting unit 221 includes a flag determination unit 271, a size decision unit 272, and a number-of-divisions decision unit 273.

The size decision unit 272 basically has a similar configuration to and performs a similar process to those of the size decision unit 172 (FIG. 11) of the image coding apparatus 100. The number-of-divisions decision unit 273 basically has a similar configuration to and performs a similar process to those of the number-of-divisions decision unit 273 (FIG. 11) of the image coding apparatus 100.

In short, the motion prediction/compensation unit 212 basically performs a similar process to that of the motion prediction/compensation unit 115 (FIG. 11), and the macroblock setting unit 221 basically performs a similar process to that of the macroblock setting unit 122 (FIG. 11).

However, the macroblock setting unit 221 sets a size in the horizontal direction of and the number of divisions of a macroblock based on the flag information, the macroblock size information, the macroblock division information, and the like, which are supplied from the lossless decoding unit 202.

Therefore, the macroblock setting unit 221 includes a flag determination unit 271 instead of the parameter determination unit 171. The flag determination unit 271 determines the flag information of the repeat flag, the fixed flag, and the like, the information being supplied from the lossless decoding unit 202.

The size decision unit 272 decides a block size in the horizontal direction of a macroblock based on the macroblock size information and the macroblock division information, which are supplied from the lossless decoding unit 202, and the determination result by the flag determination unit 271.

For example, if the flag determination unit 271 determines that the repeat flag has been set, the size decision unit 272 sets a size in the horizontal direction of each macroblock of a macroblock line of a process target to be the same as a size in the horizontal direction of each macroblock on a macroblock line immediately above the macroblock line of the process target.

Moreover, for example, if the flag determination unit 271 determines that the fixed flag has been set, the size decision unit 272 sets sizes in the horizontal direction of all macroblocks of a macroblock line of a process target to be the same. In short, the size decision unit 272 decides a size in the horizontal direction of only the leftmost macroblock of a macroblock line of a process target from the macroblock size information, and harmonizes the second macroblock and later from the left of the macroblock line of the process target with the size of the leftmost macroblock.

If either flag has not been set, the size decision unit 272 decides the size of each macroblock one by one based on the macroblock size information. In short, the size decision unit 272 checks the size of each macroblock in the image coding apparatus 100 one by one, and adjusts the size of a macroblock of a process target to the size.

On the other hand, if either flag has been set, it is possible to decide sizes in the horizontal direction of all macroblocks at once in units of macroblock lines as described above. In short, the use of the flag information supplied from the image coding apparatus 100 enables the macroblock setting unit 221 to easily decide a macroblock size.

The number-of-divisions decision unit 273 sets the number of divisions of each macroblock to be similar to the case of the image coding apparatus 100 based on the macroblock division information supplied from the image coding apparatus 100. Similarly to the case of a macroblock size, the number-of-divisions decision unit 273 may decide the numbers of divisions of all macroblocks at once in units of macroblock lines based on the flag information.

In the image decoding apparatus 200, the repeat flag and the fixed flag are not generated.

Moreover, the motion prediction/compensation unit 212 performs motion prediction and motion compensation by the macroblock size set by the macroblock setting unit 221 similarly to the motion prediction/compensation unit 115, but does not output inter prediction mode information and motion vector information.

### [Decoding Process],

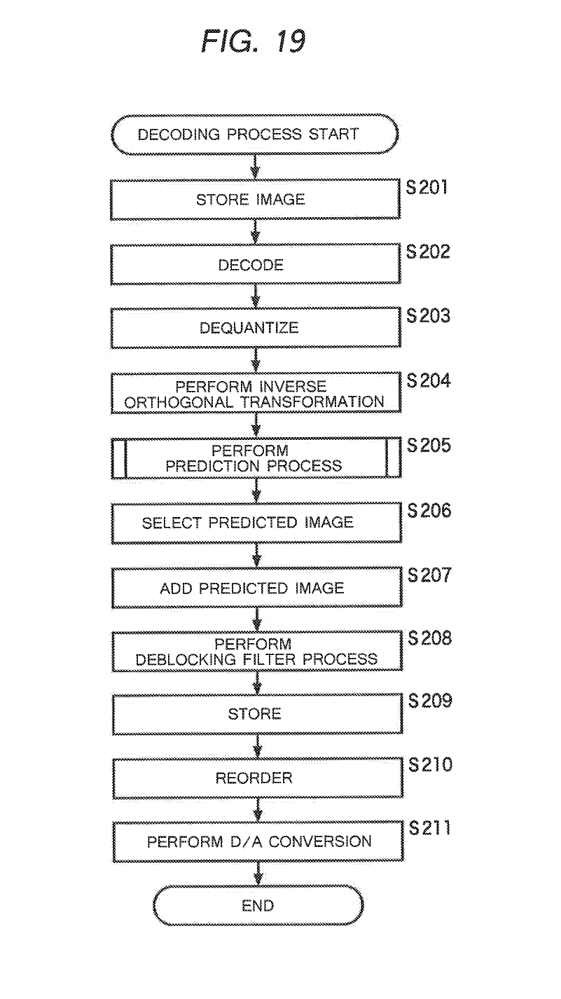

Next, a description will be given of the flow of each process executed by the image decoding apparatus 200 described above. Firstly, a description will be given of an example of the flow of a decoding process with reference to the flowchart of FIG. 19.

If the decoding process starts, the storage buffer 201 stores transmitted coded data in Step S201. In Step S202, the lossless decoding unit 202 decodes the coded data supplied from the storage buffer 201. In short, the I-, P-, and B-pictures coded by the lossless coding unit 106 of FIG. 5 are decoded.

At this time, the motion vector information, the reference frame information, the prediction mode information (the intra prediction mode or inter prediction mode), the macroblock size information, the macroblock division information, the flag information, and the like are also decoded.

In other words, if the prediction mode information is the intra prediction mode information, the prediction mode information is supplied to the intra prediction unit 211. If the prediction mode information is the inter prediction mode information, the prediction mode information and the corresponding motion vector information are supplied to the motion prediction/compensation unit 212.

Moreover, if there are the macroblock size information, the macroblock division information, the flag information, and the like, these pieces of information are supplied to the macroblock setting unit 221.

In Step S203, the dequantization unit 203 dequantizes the transform coefficients decoded by the lossless decoding unit 202 with a characteristic corresponding to the characteristic of the quantization unit 103 of FIG. 5. In Step S204, the inverse orthogonal transformation unit 204 performs an inverse orthogonal transformation on the transform coefficients dequantized by the dequantization unit 203 with a characteristic corresponding to the characteristic of the orthogonal transformation unit 104 of FIG. 5. Accordingly, the difference information corresponding to the input of the orthogonal transformation unit 104 of FIG. 5 the output of the computation unit 103) has been decoded.

In Step S205, the intra prediction unit 211 or the motion prediction/compensation unit 212 performs the prediction process of the image in accordance with the prediction mode information supplied from the lossless decoding unit 202, respectively.

In other words, if the intra prediction mode information is supplied from the lossless decoding unit 202, the intra prediction unit 211 performs an intra prediction process in infra prediction mode. Moreover, if the inter prediction mode information is supplied from the lossless decoding unit 202, the motion prediction/compensation unit 212 performs a motion prediction process in inter prediction mode.

In Step S206, the selection unit 213 selects the predicted image. In other words, the selection unit 213 is supplied with the predicted image generated by the intra prediction unit 211 or the predicted image generated by the motion prediction/compensation unit 212. The selection unit 213 selects one of them. The selected predicted image is supplied to the computation unit 205.

In Step S207, the computation unit 205 adds the predicted image selected by the process of Step S206 to the difference information obtained by the process of Step S204. Accordingly, the original image data are decoded.

In Step S208, the deblocking filter 206 filters the decoded image data supplied from the computation unit 205. Accordingly, the block distortions are removed.

In Step S209, the frame memory 209 stores the filtered decoded image data.

In Step S210, the frame reordering buffer 207 reorders the frames of the decoded image data. In other words, the order of the frames of the decoded image data, the frames having been reordered by the frame reordering buffer 102 (FIG. 5) of the image coding apparatus 100 for coding, is reordered in the original display order.

in Step S211, the D/A conversion unit 208 performs D/A conversion on the decoded image data where the frames have been reordered in the frame reordering buffer 207. The decoded image data are output to an unillustrated display to display the images.

### [Prediction Process]

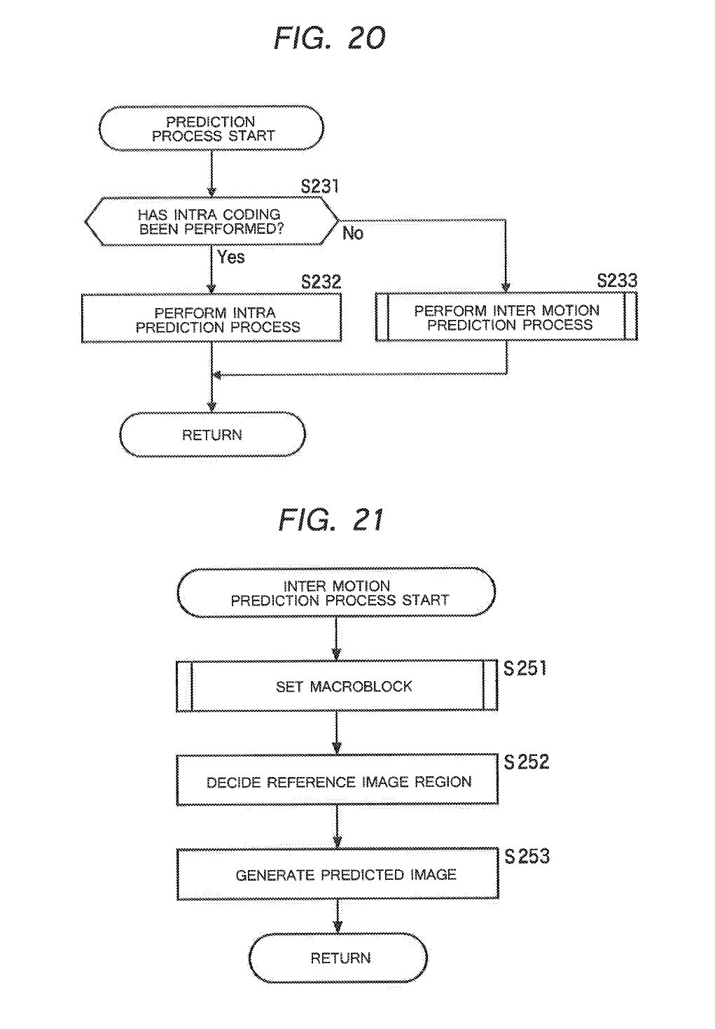

Next, a description will be given of an example of the flow of the prediction process executed in Step S205 of FIG. 19 with reference to the flowchart of FIG. 20.

If the prediction process starts, the lossless decoding unit 202 determines whether or not intra coding has been performed based on the intra prediction mode information. Determining that intra coding has been performed, the lossless decoding unit 202 supplies the intra prediction mode information to the intra prediction unit 211 and advances the process to Step S232.

in Step S232, the intra prediction unit 211 performs an intra prediction process. If the intra prediction process ends, the image decoding apparatus 200 returns the process to FIG. 19, and causes the processes after Step S206 to be executed.

Moreover, in Step S231, determining that inter coding has been performed, the lossless decoding unit 202 supplies the inter prediction mode information to the motion prediction/compensation unit 212, supplies the macroblock size information, the macroblock division information, the flag information, and the like to the macroblock setting unit 221, and advances the process to Step S233.

In Step S233, the motion prediction/compensation unit 212 performs an inter motion prediction compensation process. If the inter motion prediction compensation process ends, the image decoding apparatus 200 returns the process to FIG. 19, and causes the processes after Step S206 to be executed.

### [Intra Prediction Process]

Next, a description will be given of an example of the flow of the inter motion prediction process executed in Step S233 of FIG. 20 with reference to the flowchart of FIG. 21.

If the inter motion prediction process starts, the macroblock setting unit 221 sets a macroblock in Step S251. In Step S252, the motion prediction unit 261 decides a position (region) of a reference image based on the motion vector information. In Step S256, the motion compensation unit 262 generates a predicted image. If the predicted image is generated, the inter motion prediction process is ended. The motion prediction/compensation unit 212 returns the process to Step S233 of FIG. 20, ends the prediction process, further returns the process to Step S205 of FIG. 19, and causes the subsequent processes to be executed.

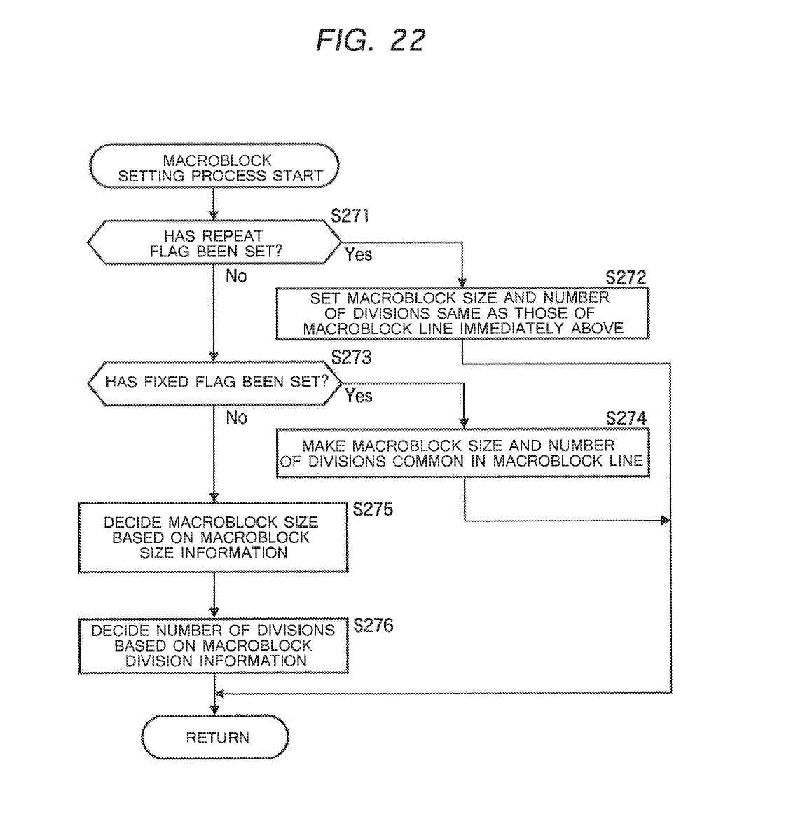

Next, a description will be given of the flow of the macroblock setting process executed in Step S251 of FIG. 21 with reference to the flowchart of FIG. 22.

If the macroblock setting process starts, the flag determination unit 271 determines in Step S271 whether or not the repeat flag has been set. Determining that the repeat flag has been set, the flag determination unit 271 advances the process to Step S272.

In Step S272, the size decision unit 272 sets the macroblock size and the number of divisions to be the same as those of a macroblock line immediately above. The number of divisions may be able to be set separately. If the process of Step S272 ends, the macroblock setting unit 221 ends the macroblock setting process, returns the process to Step S251 of FIG. 21, and advances the process to Step S252.

Determining in Step S271 that the repeat flag has not been set, the flag determination unit 271 advances the process to Step S273.

In Step S273, the flag determination unit 271 determines whether or not the fixed flag has been set. Determining that the fixed flag has been set, the flag determination unit 271 advances the process to Step S274.

In Step S274, the size decision unit 272 makes the macroblock size and the number of divisions common in the macroblock line. The number of divisions may be able to be set separately. If the process of Step S274 ends, the macroblock setting unit 221 ends the macroblock setting process returns the process to Step S251 of FIG. 21, and advances the process to Step S252.

Determining in Step S273 that the fixed flag has not been set, the flag determination unit 271 advances the process to Step S275.

In Step S275, the size decision unit 272 decides a macroblock size based on the macroblock size information. In Step S276, the number-of-divisions decision unit 273 decides the number of divisions based on the macroblock division information.

If the process of Step S276 ends, the macroblock setting unit 221 ends the macroblock setting process, returns the process to Step S251 of FIG. 21, and advances the process to Step S252.

As described above, the image decoding apparatus 200 can fix a size in the vertical direction of a macroblock and change only a size in the horizontal direction thereof based on the macroblock size information, the macroblock division information, and the like, which are supplied from the image coding apparatus 100, similarly to the case of the image coding apparatus 100. Consequently, the image decoding apparatus 200 can further improve the coding efficiency while suppressing an increase in the load, similarly to the case of the image coding apparatus 100.

Moreover, the image decoding apparatus 200 can set the sizes of a plurality of macroblocks at once based on the flag information of the repeat flag, the fixed flag, or the like, which is supplied from the image coding apparatus 100. In this manner, the use of the flag information enables the image decoding apparatus 200 to improve the coding efficiency more easily.

### 3. Third Embodiment

### Personal Computer

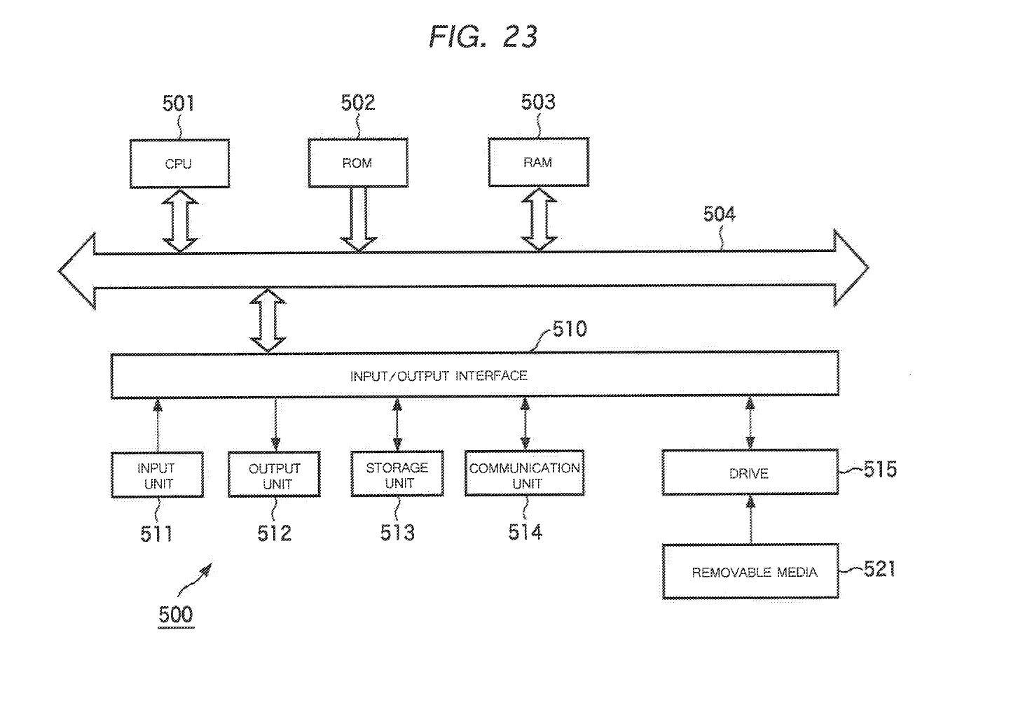

The above-mentioned series of processes can be executed by hardware, or software. In this case, for example, a personal computer shown in FIG. 23 may be configured.

In FIG. 23, a CPU 501 of a personal computer 500 executes various processes in accordance with a program stored in a ROM (Read Only Memory) 502 or a program loaded into a RAM (Random Access Memory) 503 from a storage unit 513. Data required for the CPU 501 to execute various processes are also appropriately stored in the RAM 503.

The CPU 501, the ROM 502, and the RAM 503 are connected to each other via a bus 504. Moreover, an input/output interface 510 is also connected to the bus 504.

The input/output interface 510 is connected to an input unit 511 constructed of a keyboard, a mouse and the like, an output unit 512 constructed of a display constructed of a CRT (Cathode Ray Tube), an LCD (Liquid Crystal Display), or the like, and a speaker, a storage unit 513 configured of a hard disk, or the like, and a communication unit 514 configured of a modem, or the like. The communication unit 514 performs a communication process via a network including the Internet.

Moreover, the input/output interface 510 is connected also to a drive 515 as necessary to appropriately mount a removable media 521 such as a magnetic disk, an optical disc, a magneto-optical disk, or a semiconductor memory, and computer programs read out from them are installed in the storage unit 513 as necessary.

If the above-mentioned series of processes is executed by software, a program configuring the software is installed from the network or a recording medium.

As shown in FIG. 23, the recording medium is, for example, configured not only of the removable media 521 constructed of a magnetic disk (including a flexible disk), an optical disc (including a CD-ROM (Compact Disc-Read Only Memory) and a DVD (Digital Versatile Disc)), a magneto-optical disk (including an MD (Mini Disc)), a semiconductor memory, or the like, in which the program is recorded, which is distributed separately from the main body of the apparatus to distribute the program to a user, but also of the ROM 502 or a hard disk included in the storage unit 513, or the like, in which the program is recorded, which is distributed to a user in a state of being incorporated in advance in the main body of the apparatus.

The program to be executed by the computer may be a program where processes are chronologically executed following the order of explanation in the description, or may be a program where processes are executed in parallel or at necessary timings such as when a call is made.

Moreover, in the description, the step of describing a program to be recorded in the recording medium naturally includes processes to be chronologically executed following the described order, and also processes to be executed in parallel or individually, which are not necessarily executed chronologically.

Moreover, in the description, the system indicates the entire apparatus configured of a plurality of devices (devices).

Moreover, the configuration described as one device (or processing unit) in the above may be divided to configure a plurality of devices (or processing units). Conversely, the configurations described as a plurality of devices (or processing units) in the above may be configured as one device (or processing unit). Moreover, a configuration other than the above-mentioned ones may be added to the configuration of each device (or processing unit). Furthermore, if the configuration and operation as the entire system are substantially the same, apart of the configuration of a certain device (or processing unit) may be included in the configuration of another device (or processing unit). In short, embodiments of the present technology are not limited to the above-mentioned embodiments, but various modifications can be made without departing from the gist of the present technology.

For example, the above-mentioned image coding apparatus 100 and image decoding apparatus 200 can be applied to an arbitrary electronic device. A description will hereinafter be given of the example.

### 4. Fourth Embodiment

### Television Receiver

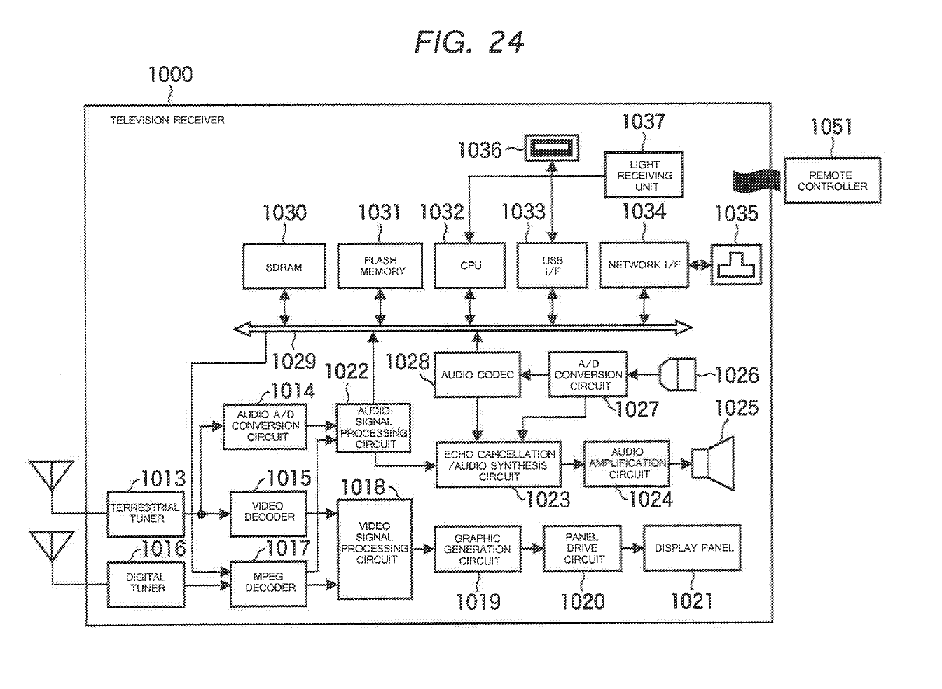

FIG. 24 is a block diagram illustrating a main configuration example of a television receiver using the image decoding apparatus 200.

A television receiver 1000 shown in FIG. 24 includes a terrestrial tuner 1013, a video decoder 1015, a video signal processing circuit 1018, a graphic generation circuit 1019, a panel drive circuit 1020, and a display panel 1021.

The terrestrial tuner 1013 demodulates a broadcast wave signal of analog terrestrial broadcasting after receiving via an antenna, acquires a video signal, and supplies the video signal to the video decoder 1015. The video decoder 1015 performs a decoding process on the video signal supplied from the terrestrial tuner 1013, and supplies the obtained digital component signal to the video signal processing circuit 1018.

The video signal processing circuit 1018 performs a predetermined process such as noise removal on the video data supplied from the video decoder 1015 and supplies the obtained video data to the graphic generation circuit 1019.

The graphic generation circuit 1019 generates video data of a program to be displayed on the display panel 1021, image data by a process based on an application to be supplied via a network, and the like and supplies the generated video data and image data to the panel drive circuit 1020. Moreover, the graphic generation circuit 1019 appropriately performs processes such as generating video data (graphic) for displaying a screen to be used by a user for selection of items and supplying to the panel drive circuit 1020 video data obtained by superimposing the generated video data on video data of a program, and the like.

The panel drive circuit 1020 drives the display panel 1021 based on the data supplied from the graphic generation circuit 1019, and displays the video of the program and the above-mentioned various screens on the display panel 1021.

The display panel 1021 is constructed of an LCD (Liquid Crystal Display) and the like, and is caused to display the video of the program, and the like in accordance with the control by the panel drive circuit 1020.

Moreover, the television receiver 1000 includes also an audio A/D (Analog/Digital) conversion circuit 1014, an audio signal processing circuit 1022, an echo cancellation/audio synthesis circuit 1023, an audio amplification circuit 1024, and a speaker 1025.

The terrestrial tuner 1013 acquires not only a video signal but also an audio signal by demodulating the received broadcast wave signal. The terrestrial tuner 1013 supplies the acquired audio signal to the audio A/D conversion circuit 1014.

The audio A/D conversion circuit 1014 performs an A/D conversion process on the audio signal supplied from the terrestrial tuner 1013, and supplies the obtained digital audio signal to the audio signal processing circuit 1022.

The audio signal processing circuit 1022 performs a predetermined process such as noise removal on the audio data supplied from the audio A/D conversion circuit 1014 and supplies the obtained audio data to the echo cancellation/audio synthesis circuit 1023.

The echo cancellation/audio synthesis circuit 1023 supplies to the audio amplification circuit 1024 the audio data supplied from the audio signal processing circuit 1022.

The audio amplification circuit 1024 performs a D/A conversion process and an amplification process on the audio data supplied from the echo cancellation/audio synthesis circuit 1023, and outputs the audio from the speaker 1025 after adjusting to a predetermined volume.

Furthermore, the television receiver 1000 includes also a digital tuner 1016 and an MPEG decoder 1017.

The digital tuner 1016 demodulates a broadcast wave signal of digital broadcasting (digital terrestrial broadcasting and BS (Broadcasting Satellite)/CS (Communications Satellite) digital broadcasting) after receiving via an antenna, acquires MPEG-TS (Moving Picture Experts Group-Transport Stream), and supplies it to the MPEG decoder 1017.

The MPEG decoder 1017 descrambles MPEG-TS supplied from the digital tuner 1016, and extracts a stream including the data of a program being a playback target (viewing target). The MPEG decoder 1017 decodes audio packets constituting the extracted stream to supply the obtained audio data to the audio signal processing circuit 1022, and decodes video packets constituting the stream to supply the obtained video data to the video signal processing circuit 1018. Moreover, the MPEG decoder 1017 supplies EPG (Electronic Program Guide) data extracted from MPEG-TS to a CPU 1032 via an unillustrated path.

The television receiver 1000 uses the above-mentioned image decoding apparatus 200 as the MPEG decoder 1017 that decodes video packets in this manner. MPEG-TS transmitted from a broadcasting station and the like is coded by the image coding apparatus 100.

Similarly to the case of the image decoding apparatus 200, the MPEG decoder 1017 decides a size in the horizontal direction of a macroblock by use of the macroblock size information, the flag information, or the like, which is extracted from the coded data supplied from the broadcasting station (the image coding apparatus 100), and performs inter coding by use of the setting. Therefore, the MPEG decoder 1017 can further improve the coding efficiency while suppressing an increase in the load.

Similarly to the case of the video data supplied from the video decoder 1015, a predetermined process is performed on the video data supplied from the MPEG decoder 1017 in the video signal processing circuit 1018, and the generated video data and the like are appropriately superimposed thereon in the graphic generation circuit 1019 to be supplied to the display panel 1021 via the panel drive circuit 1020 for display of the image.

Similarly to the case of the audio data supplied from the audio A/D conversion circuit 1014, a predetermined process is performed on the audio data supplied from the MPEG decoder 1017 in the audio signal processing circuit 1022, the audio data being supplied to the audio amplification circuit 1024 via the echo cancellation/audio synthesis circuit 1023 for a D/A conversion process and an amplification process. As a result, the audio adjusted to a predetermined volume is output from the speaker 1025.

Moreover, the television receiver 1000 includes also a microphone 1026 and an A/D conversion circuit 1027.

The A/D conversion circuit 1027 receives a signal of a user's voice captured by the microphone 1026 provided to the television receiver 1000 for a voice conversation, performs an A/D conversion process on the received audio signal, and supplies the obtained digital audio data to the echo cancellation/audio synthesis circuit 1023.

If the data of the voice of a user (user A) of the television receiver 1000 is supplied from the A/D conversion circuit 1027, the echo cancellation/audio synthesis circuit 1023 outputs audio data obtained by canceling the echo of the audio data of the user A to synthesize with another audio data, and the like, from the speaker 1025 via the audio amplification circuit 1024.

Furthermore, the television receiver 1000 includes also an audio codec 1028, an internal bus 1029, an SDRAM (Synchronous Dynamic Random Access Memory) 1030, a flash memory 1031, the CPU 1032, a USB (Universal Serial Bus) I/F 1033, and a network I/F 1034.

The A/D conversion circuit 1027 receives the signal of the voice of the user captured by the microphone 1026 provided to the television receiver 1000 for a voice conversation, performs an A/D conversion process on the received audio signal, and supplies the obtained digital audio data to the audio codec 1028.

The audio codec 1028 converts the audio data supplied from the A/D conversion circuit 1027 into data in a predetermined format for transmission via a network to supply the data to the network I/F 1034 via the internal bus 1029.

The network I/F 1034 is connected to a network via a cable mounted on a network terminal 1035. The network I/F 1034 transmits the audio data supplied from the audio codec 1028 to, for example, another device connected to the network. Moreover, the network I/F 1034 receives, for example, audio data transmitted from another device connected via a network, via the network terminal 1035, and supplies the data to the audio codec 1028 via the internal bus 1029.

The audio codec 1028 converts the audio data supplied from the network I/F 1034 into data in a predetermined format, and supplies the data to the echo cancellation/audio synthesis circuit 1023.

The echo cancellation/audio synthesis circuit 1023 outputs audio data obtained by canceling the echo of the audio data supplied from the audio codec 1028 to synthesize with another audio data, and the like, from the speaker 1025 via the audio amplification circuit 1024.

The SCRAM 1030 stores various data required by the CPU 1032 to perform processes.

The flash memory 1031 stores a program executed by the CPU 1032. The program stored in the flash memory 1031 is read out by the CPU 1032 at predetermined timings such as at the time of starting the television receiver 1000. The flash memory 1031 stores also EPG data acquired via digital broadcasting, data acquired from a predetermined server via a network, and the like.

For example, MPEG-TS including content data acquired from a predetermined server via a network by the control of the CPU 1032 is stored in the flash memory 1031. The flash memory 1031, for example, supplies the MPEG-TS to the MPEG decoder 1017 via the internal bus 1029 by the control of the CPU 1032.

The MPEG decoder 1017 processes the MPEG-TS similarly to the case of MPEG-TS supplied from the digital tuner 1016. In this manner, the television receiver 1000 can decode content data including video and audio by use of the MPEG decoder 1017 after receiving the content data via a network, and display the video and output the audio.

Moreover, the television receiver 1000 includes also a light receiving unit 1037 that receives an infrared signal to be transmitted from a remote controller 1051.

The light receiving unit 1037 receives infrared radiation from the remote controller 1051, and outputs a control code indicating the content of a user's operation, which has been obtained by demodulation, to the CPU 1032.

The CPU 1032 executes the program stored in the flash memory 1031, and controls the entire operation of the television receiver 1000 in accordance with the control code supplied from the light receiving unit 1037, and the like. The CPU 1032 is connected to each part of the television receiver 1000 via an unillustrated path.

The USE I/F 1033 transmits and receives data to and from an external device of the television receiver 1000, which is connected via a USB cable mounted on a USB terminal 1036. The network I/F 1034 is connected to a network via a cable mounted on the network terminal 1035, and transmits and receives data other than audio data to and from various devices connected to the network.

The television receiver 1000 uses the image decoding apparatus 200 as the MPEG decoder 1017 to make it possible to improve the coding efficiency of a broadcast wave signal to receive via an antenna and content data to acquire via a network while suppressing an increase in the load, and realize a real time process at lower cost.

### 5. Fifth Embodiment

### Mobile Phone

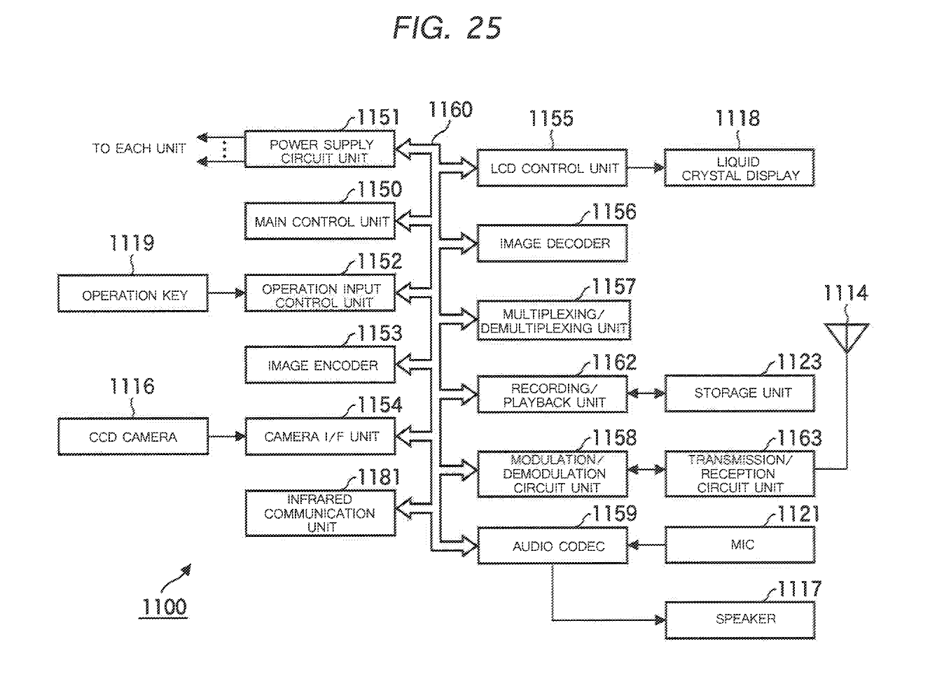

FIG. 25 is a block diagram illustrating a main configuration example of a mobile phone using the image coding apparatus 100 and the image decoding apparatus 200.

A mobile phone 1100 shown in FIG. 25 includes a main control unit 1150 that generally controls each unit, a power supply circuit unit 1151, an operation input control unit 1152, an image encoder 1153, a camera I/F unit 1154, an LCD control unit 1155, an image decoder 1156, a multiplexing/demultiplexing unit 1157, a recording/playback unit 1162, a modulation/demodulation circuit unit 1158, and an audio codec 1159. They are connected to each other via a bus 1160.

Moreover, the mobile phone 1100 includes an operation key 1119, a CCD (Charge Coupled Devices) camera 1116, a liquid crystal display 1118, a storage unit 1123, a transmission/reception circuit unit 1163, an antenna 1114, a microphone (mic) 1121, and a speaker 1117.

If an end-call and power key is turned on by a user's operation, the power supply circuit unit 1151 supplies power to each part from a battery pack to start the mobile phone 1100 to an operational state.

The mobile phone 1100 performs various operations such as transmission/reception of audio signals, transmission/reception of emails and image data, the taking of images, or data recording in various modes such as voice communication mode and data communication mode based on the control of the main control unit 1150 constructed of a CPU, a ROM, a RAM and the like.

For example, in voice communication mode, the mobile phone 1100 converts an audio signal collected by the microphone (mic) 1121 into digital audio data by the audio codec 1159, performs a spread spectrum process on the data in the modulation/demodulation circuit unit 1158, and performs a digital-to-analog conversion process and a frequency conversion process thereon at the transmission/reception circuit unit 1163. The mobile phone 1100 transmits a signal for transmission obtained by the conversion processes to an unillustrated base station via the antenna 1114. The signal for transmission (audio signal) transmitted to the base station is supplied to a mobile phone of a party on the other end of line via the public switched telephone network.

Moreover, for example, in voice communication mode, the mobile phone 1100 amplifies the received signal received by the antenna 1114 at the transmission/reception circuit unit 1163, further performs a frequency conversion process and an analog-to-digital conversion process, performs an inverse spread spectrum process at the modulation/demodulation circuit unit 1158, and converts the signal into an analog audio signal by the audio codec 1159. The mobile phone 1100 outputs the analog audio signal obtained by the conversion from the speaker 1117.

Furthermore, for example, if an email is transmitted in data communication mode, the mobile phone 1100 accepts text data of an email input by the operation of the operation key 1119 at the operation input control unit 1152. The mobile phone 1100 processes the text data at the main control unit 1150 and displays the data as an image on the liquid crystal display 1118 via the LCD control unit 1155.

Moreover, the mobile phone 1100 generates email data based on the text data accepted by the operation input control unit 1152, a user's direction, and the like at the main control unit 1150. The mobile phone 1100 performs a spread spectrum process on the email data at the modulation/demodulation circuit unit 1158 and performs a digital-to-analog conversion process and a frequency conversion process at the transmission/reception circuit unit 1163. The mobile phone 1100 transmits a signal for transmission obtained by the conversion processes to an unillustrated base station via the antenna 1114. The signal for transmission (email) transmitted to the base station is supplied to a predetermined destination via a network, a mail server and the like.

Moreover, for example, if an email is received in data communication mode, the mobile phone 1100 amplifies the signal transmitted from the base station after receiving at the transmission/reception circuit unit 1163 via the antenna 1114 to further perform a frequency conversion process and an analog-to-digital conversion process thereon. The mobile phone 1100 performs an inverse spread spectrum process on the received signal at the modulation/demodulation circuit unit 1158 to reconstruct the original email data. The mobile phone 1100 displays the reconstructed email data on the liquid crystal display 1118 via the LCD control unit 1155.

The mobile phone 1100 can also records (stores) the received email data in the storage unit 1123 via the recording/playback unit 1162.

The storage unit 1123 is an arbitrary rewritable storage medium. The storage unit 1123 may be, for example, a semiconductor memory such as a RAM or an internal flash memory, a hard disk, or a removable media such as a magnetic disk, a magneto-optical disk, an optical disc, a USE memory or a memory card, and may be naturally other than these.

Furthermore, for example, if image data are transmitted in data communication mode, the mobile phone 1100 generates image data with the CCD camera 1116 by imaging. The CCD camera 1116 includes optical devices such as a lens and a diaphragm, and a CCD as a photoelectric conversion element, and images an object, converts the intensity of the received light into an electric signal, and generates image data of an image of the object. The CCD camera 1116 codes the image data with the image encoder 1153 via the camera I/F unit 1154 to convert into the coded image data.

The mobile phone 1100 uses the above-mentioned image coding apparatus 100 as the image encoder 1153 that performs such a process. Similarly to the case of the image coding apparatus 100, while fixing a size in the vertical direction of a macroblock, the image encoder 1153 sets a size in the horizontal direction thereof depending on various parameters.

Image data are coded by using a predicted image generated by use of the macroblock set in this manner to enable the image encoder 1153 to further improve the coding efficiency while suppressing an increase in the load.

At the same time, the mobile phone 1100 performs analog-to-digital conversion on the audio collected by the microphone (mic) 1121 while imaging with the CCD camera 1116 for further coding, at the audio codec 1159.

The mobile phone 1100 multiplexes the coded image data supplied from the image encoder 1153 and the digital audio data supplied from the audio codec 1159 in a predetermined scheme at the multiplexing/demultiplexing unit 1157. The mobile phone 1100 performs a spread spectrum process on the multiplexed data obtained as a result at the modulation/demodulation circuit unit 1158, and performs a digital-to-analog conversion process and a frequency conversion process at the transmission/reception circuit unit 1163. The mobile phone 1100 transmits a signal for transmission obtained by the conversion processes to an unillustrated base station via the antenna 1114. The signal for transmission (image data) transmitted to the base station is supplied to a party on the other end of line via a network, and the like.

If the image data are not transmitted, the mobile phone 1100 can display the image data generated by the CCD camera 1116 on the liquid crystal display 1118 not via the image encoder 1153 but via the LCD control unit 1155.

Moreover, for example, if data of a moving image file linked to a simple website, and the like are received in data communication mode, the mobile phone 1100 amplifies the signal transmitted from the base station after receiving at the transmission/reception circuit unit 1163 via the antenna 1114 to further perform a frequency conversion process and an analog-to-digital conversion process thereon. The mobile phone 1100 performs an inverse spread spectrum process on the received signal at the modulation/demodulation circuit unit 1158 to reconstruct the original the original multiplexed data. The mobile phone 1100 demultiplexes the multiplexed data at the multiplexing/demultiplexing unit 1157 to divide the data into the coded image data and audio data.

The mobile phone 1100 decodes the coded image data at the image decoder 1156 to generate playback moving image data and display the data on the liquid crystal display 1118 via the LCD control unit 1155. Accordingly, for example, moving image data included in the moving image file linked to a simple website are displayed on the liquid crystal display 1118.

The mobile phone 1100 uses the above-mentioned image decoding apparatus 200 as the image decoder 1156 that performs such a process. In short, similarly to the case of the image decoding apparatus 200, the image decoder 1156 decides a size in the horizontal direction of a macroblock by use of the macroblock size information, the flag information, or the like, which has been extracted from the coded data supplied from the image encoder 1153 of another device, and performs inter coding by use of the setting. Therefore, the image decoder 1156 can further improve the coding efficiency while suppressing an increase in the load.

At this time, the mobile phone 1100 simultaneously converts the digital audio data into an analog audio signal at the audio codec 1159 and outputs the signal from the speaker 1117. Accordingly, for example, the audio data included in the moving image file linked to a simple website are played back.

Similarly to the case of an email, the mobile phone 1100 can also record (store) the received data linked to a simple website and the like in the storage unit 1123 via the recording/playback unit 1162.

Moreover, the mobile phone 1100 can analyze a two-dimensional code imaged and obtained by the CCD cameral 1116 at the main control unit 1150 to acquire information recorded in the two-dimensional code.

Furthermore, the mobile phone 1100 can communicate with an external device by infrared radiation by an infrared communication unit 1181.

The use of the image coding apparatus 100 as the image encoder 1153 enables the mobile phone 1100 to improve the coding efficiency, for example, of when image data generated in the CCD camera 1116 are coded and transmitted while suppressing an increase in the load, and realize a real time process at lower cost.

Moreover, the use of the image decoding apparatus 200 as the image decoder 1156 enables the mobile phone 1100 to improve the coding efficiency, for example, of data (coded data) of a moving image file linked to a simple website and the like while suppressing an increase in the load, and realize a real time process at lower cost.

The mobile phone 1100 has been described to use the CCD camera 1116 in the above, but may use an image sensor using a CMOS (Complementary Metal Oxide Semiconductor) (CMOS image sensor) instead of the CCD camera 1116. Also in this case, similarly to the case of using the CCD camera 1116, the mobile phone 1100 can image an object and generate image data of the image of the object.

Moreover, the description has been given as the mobile phone 1100 in the above; however, it is possible to apply the image coding apparatus 100 and the image deciding apparatus 200 to any device, similarly to the case of the mobile phone 1100, as long as the device has an imaging function and a communication function similar to those of the mobile phone 1100, for example, a PDA (Personal Digital Assistants) smartphone, a UMPC (Ultra Mobile Personal Computer), a netbook, a note-type personal computer.

### 6. Sixth Embodiment

### Hard Disk Recorder

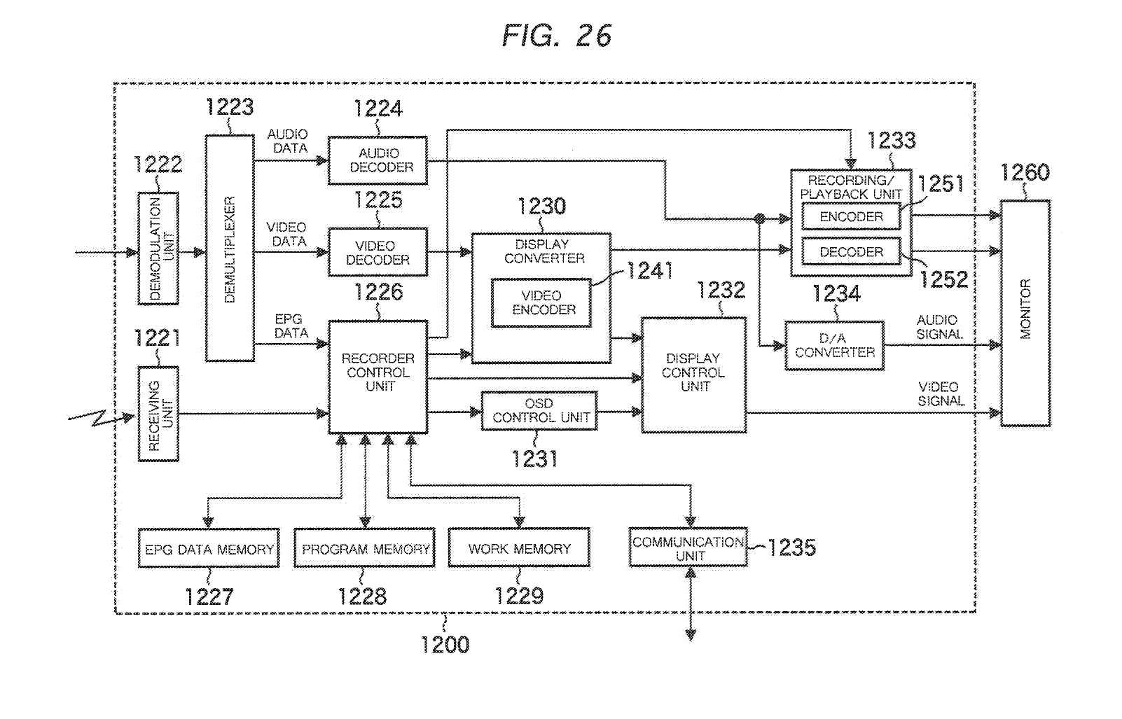

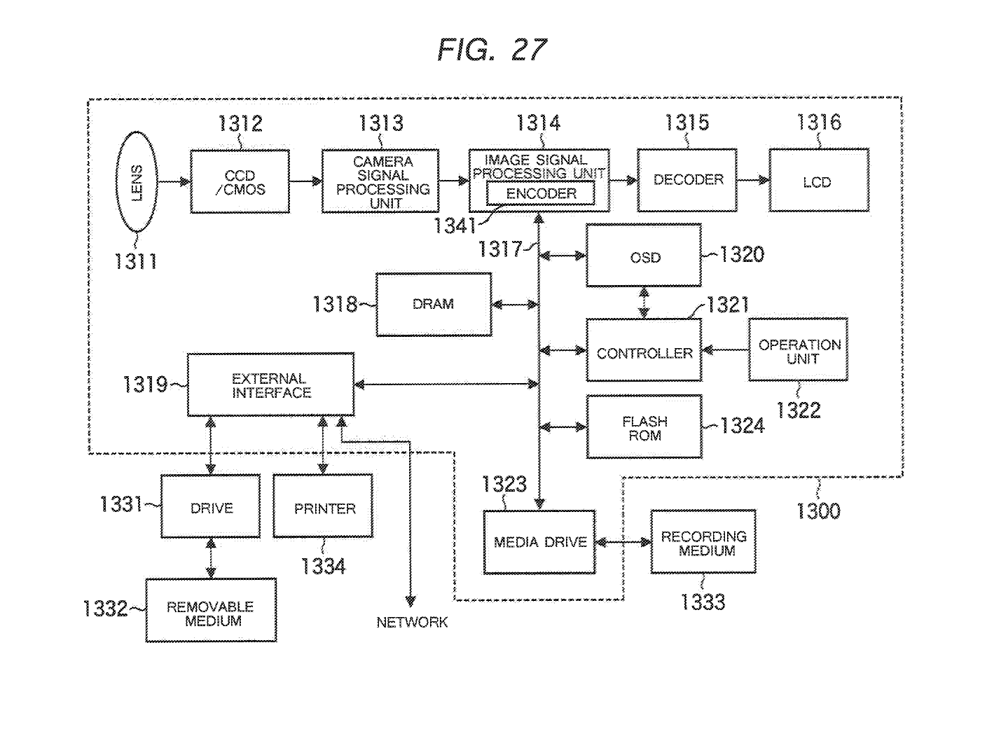

FIG. 26 is a block diagram illustrating a main configuration example of a hard disk recorder using the image coding apparatus 100 and the image decoding apparatus 200.

A hard disk recorder (HDD recorder) 1200 shown in FIG. 26 is a device that retains audio and video data of a broadcast program included in a broadcast wave signal (television signal) transmitted by a satellite, an antenna on the ground, or the like, the signal being received by a tuner, in an integral hard disk, and provides a user with the retained data at a timing in accordance with a user's instruction.

For example, the hard disk recorder 1200 extracts audio data and video data from a broadcast wave signal, and appropriately decodes the data to store the data in the integral hard disk. Moreover, for example, the hard disk recorder 1200 can also acquire audio and video data from another apparatus via a network, and appropriately decode the data to store the data in the integral hard disk.

Furthermore, for example, the hard disk recorder 1200 can decode audio and video data recorded in the integral hard disk to supply the data to a monitor 1260, display the image on a screen of the monitor 1260, and output the audio from a speaker of the monitor 1260. Moreover, for example, the hard disk recorder 1200 can also decode audio data and video data extracted from a broadcast wave signal acquired via the tuner, or audio and video data acquired from another device via a network to supply the data to the monitor 1260, display the image on the screen of the monitor 1260 and output the audio from the speaker of the monitor 1260.

Naturally, operations other than these are possible.

As shown in FIG. 26, the hard disk recorder 1200 includes a receiving unit 1221, a demodulation unit 1222, a demultiplexer 1223, an audio decoder 1224, a video decoder 1225, and a recorder control unit 1226. The hard disk recorder 1200 further includes an EPG data memory 1227, a program memory 1228, a work memory 1229, a display converter 1230, an OSD (On Screen Display) control unit 1231, a display control unit 1232, a recording/playback unit 1233, a D/A converter 1234, and a communication unit 1235.

Moreover, the display converter 1230 includes a video encoder 1241. The recording/playback unit 1233 includes an encoder 1251 and a decoder 1252.

The receiving unit 1221 receives an infrared signal from a remote control (not shown) and converts the infrared signal into an electric signal to output to the recorder control unit 1226. The recorder control unit 1226 is configured, for example, of a microprocessor and the like, and executes various processes in accordance with a program stored in the program memory 1228. At this time, the recorder control unit 1226 uses the work memory 1229 as necessary.

The communication unit 1235 is connected to a network, and performs a communication process with another device via the network. For example, the communication unit 1235 is controlled by the recorder control unit 1226, communicates with a tuner (not shown), and outputs a station selection control signal mainly to the tuner.

The demodulation unit 1222 demodulates the signal supplied from the tuner to output the signal to the demultiplexer 1223. The demultiplexer 1223 demultiplexes the data supplied by the demodulation unit 1222 into audio data, video data, and EPG data, to output the audio data, the video data, and the EPG data to the audio decoder 1224, the video decoder 1225, and the recorder control unit 1226, respectively.

The audio decoder 1224 decodes the input audio data to output the audio data to the recording/playback unit 1233. The video decoder 1225 decodes the input video data to output the video data to the display converter 1230. The recorder control unit 1226 supplies and stores the input EPG data to and in the EPG data memory 1227.

The display converter 1230 encodes the video data supplied from the video decoder 1225 or the recorder control unit 1226 into, for example, video data in NTSC (National Television Standards Committee) format by the video encoder 1241 to output the data to the recording/playback unit 1233. Moreover, the display converter 1230 converts the display size of the video data supplied from the video decoder 1225 or the recorder control unit 1226 into a size corresponding to the size of the monitor 1260, and converts the video data into video data in NTSC format by the video encoder 1241 to convert it into an analog signal and output it to the display control unit 1232.

The display control unit 1232 superimposes an OSD signal output by the OSD (On Screen Display) control unit 1231 under the control of the recorder control unit 1226 on the video signal input by the display converter 1230 to output the signal to a display of the monitor 1260 for display.

The monitor 1260 is also supplied with an analog signal converted by the D/A converter 1234 from the audio data output by the audio decoder 1224. The monitor 1260 outputs the audio signal from the integral speaker.

The recording/playback unit 1233 includes a hard disk as a recording medium that records video data, audio data, and the like.

The recording/playback unit 1233 encodes, for example, the audio data supplied from the audio decoder 1224 by the encoder 1251. Moreover, the recording/playback unit 1233 encodes the video data supplied from the video encoder 1241 of the display converter 1230, by the encoder 1251. The recording/playback unit 1233 synthesizes the coded data of the audio data and the coded data of the video data by a multiplexer. The recording/playback unit 1233 amplifies the synthesized data by channel coding, and writes the data on the hard disk via a recording head.

The recording/playback unit 1233 plays back the data recorded in the hard disk via a playback head, and amplifies the data to demultiplex the data into audio data and video data by the demultiplexer. The recording/playback unit 1233 decodes the audio data and the video data by the decoder 1252. The recording/playback unit 1233 performs D/A conversion on the decoded audio data to output the data to the speaker of the monitor 1260. Moreover, the recording/playback unit 1233 performs D/A conversion on the decoded video data to output the data to the display of the monitor 1260.

The recorder control unit 1226 reads out the latest EPG data from the EPG data memory 1227 based on a user's instruction indicated by an infrared signal from the remote controller, the infrared signal being received via the receiving unit 1221, and supplies the EPG data to the OSD control unit 1231. The OSD control unit 1231 creates image data corresponding to the input EPG data to output the data to the display control unit 1232. The display control unit 1232 outputs the video data input by the OSD control unit 1231 to the display of the monitor 1260 for display. Accordingly, EPG (electronic program guide) is displayed on the display of the monitor 1260.

Moreover, the hard disk recorder 1200 can acquire various data such as video data, audio data or EPG data, which are supplied from another device via a network such as the Internet.

The communication unit 1233 is controlled by the recorder control unit 1226, acquires the coded data of video data, audio data, EPG data, and the like, which are transmitted from another device via a network, to supply it to the recorder control unit 1226. The recorder control unit 1226 supplies, for example, the acquired coded data of the video and audio data to the recording/playback unit 1233 to store in the hard disk. At this time, the recorder control unit 1226 and the recording/playback unit 1233 may perform processes such as reencoding as necessary.

Moreover, the recorder control unit 1226 decodes the acquired coded data of the video and audio data and supplies the obtained video data to the display converter 1230. Similarly to the video data supplied from the video decoder 1225, the display converter 1230 processes the video data supplied from the recorder control unit 1226 to supply it to the monitor 1260 via the display control unit 1232, and displays the image.

Moreover, coinciding with the image display, the recorder control unit 1226 may supply the decoded audio data to the monitor 1260 via the D/A converter 1234 to output the audio from the speaker.

Furthermore, the recorder control unit 1226 decodes the acquired coded data of the EPG data, and supplies the decoded EPG data to the EPG data memory 1227.

The hard disk recorder 1200 described above uses the image decoding apparatus 200 as a decoder integrated in the video decoder 1225, the decoder 1252, and the recorder control unit 1226. In short, similarly to the case of the image decoding apparatus 200, the decoder integrated in the video decoder 1225, the decoder 1252, and the recorder control unit 1226 decides a size in the horizontal direction of a macroblock by use of the macroblock size information, the flag information, or the like, which is extracted from the coded data supplied by the image coding apparatus 100, and performs inter coding by use of the setting. Therefore, the decoder integrated in the video decoder 1225, the decoder 1252, and the recorder control unit 1226 can further improve the condign efficiency while suppressing an increase in the load.

Therefore, the hard disk recorder 1200 can improve the coding efficiency, for example, of video data (coded data) to be received by the tuner and the communication unit 1235 and video data (coded data) to be played back by the recording/playback unit 1233 while suppressing an increase in the load, and realize a real time process at lower cost.

Moreover, the hard disk recorder 1200 uses the image coding apparatus 100 as the encoder 1251. Therefore, similarly to the case of the image coding apparatus 100, while fixing a size in the vertical direction of a macroblock, the encoder 1251 sets a size in the horizontal direction depending on various parameters. The coding of image data by use of a predicted image generated by use of the macroblock set in this manner enables the encoder 1251 to further improve the coding efficiency while suppressing an increase in the load.

Therefore, the hard disk recorder 1200 can improve the coding efficiency, for example, of coded data to be recorded in the hard disk while suppressing an increase in the load and realize a real time process at lower cost.

The description has been given in the above of the hard disk recorder 1200 that records video data and audio data in a and disk; however, naturally, a recording medium can be any type. The image coding apparatus 100 and the image decoding apparatus 200 can be applied even to a recorder to which a recording medium other than a hard disk, such as a flash memory, an optical disc, or a video tape, similarly to the case of the above-mentioned hard disk recorder 1200.

### 7. Seventh Embodiment

### Camera

FIG. 25 is a block diagram illustrating a main configuration example of a camera using the image coding apparatus 100 and the image decoding apparatus 200.

A camera 1300 shown in FIG. 25 images an object, displays the image of the object on an LCD 1316, and records the image as image data in a recording media 1333.

A lens block 1311 causes light (in other words, a picture of the object) to be incident on a CCD/CMOS 1312. The CCD/CMOS 1312 is an image sensor using a CCD or CMOS, converts the intensity of the received light into an electric signal to supply it to a camera signal processing unit 1313.

The camera signal processing unit 1313 converts the electric signal supplied from the CCD/CMOS 1312 into chrominance signals of Y, Cr and Cb to supply it to an image signal processing unit 1314. Under the control of a controller 1321, the image signal processing unit 1314 performs predetermined image processing on an image signal supplied from the camera signal processing unit 1313 and codes the image signal by the encoder 1341. The image signal processing unit 1314 supplies the coded data generated by coding the image signal to a decoder 1315. Furthermore, the image signal processing unit 1314 acquires data for display generated in an on screen display (OSD) 1320 and supplies the data to the decoder 1315.

In the above processes, the camera signal processing unit 1313 appropriately uses a DRAM (Dynamic Random Access Memory) 1318 connected via a bus 1317, and causes the DRAM 1318 to hold image data, coded data where the image data are coded, and the like as necessary.

The decoder 1315 decodes the coded data supplied from the image signal processing unit 1314 and supplies the obtained image data (decoded image data) to the LCD 1316. Moreover, the decoder 1315 supplies the data for display supplied from the image signal processing unit 1314 to the LCD 1316. The LCD 1316 appropriately synthesizes an image of the decoded image data and an image of the data for display, which have been supplied from the decoder 1315, and displays the synthesized image.

The on screen display 1320 outputs the data for display such as a menu screen formed of symbols, characters, or graphics and icons to the image signal processing unit 1314 via the bus 1317 under the control of the controller 1321.

The controller 1321 executes various processes based on signals indicating the contents of commands given by a user by use of an operation unit 1322, and controls the image signal processing unit 1314, the DRAM 1318, an external interface 1319, the on screen display 1320, a media drive 1323, and the like via the bus 1317. A program, data, and the like, which are necessary for the controller 1321 to execute various processes, are stored in a FLASH ROM 1324.

For example, the controller 1321 can code the image data stored in the DRAM 1318 and decode the coded data stored in the DRAM 1318 instead of the image signal processing unit 1314 and the decoder 1315. At this time, the controller 1321 may perform coding and decoding processes in compliance with a scheme similar to a coding and decoding scheme of the image signal processing unit 1314 and the decoder 1315, or may perform coding and decoding processes in a scheme with which the image signal processing unit 1314 and the decoder 1315 do not comply.

Moreover, for example, if a instruction to start printing an image is given from the operation unit 1322, the controller 1321 reads out image data from the DRAM 1318 and supplies the image data to a printer 1334 connected to the external interface 1319 via the bus 1317 for printing.

Furthermore, for example, if a instruction to record an image is given from the operation unit 1322, the controller 1321 reads out coded data from the DRAM 1318 and supplies the coded data to the recording media 1333 mounted on the media drive 1323 via the bus 1317 for storage.

The recording media 1333 is an arbitrary readable and writable removable media such as a magnetic disk, a magneto-optical disk, an optical disc, or a semiconductor memory. Naturally, the type of the recording media 1333 as a removable media is also arbitrary, and may be a tape device, a disk, or a memory card, and may be naturally a non-contact IC card or the like.

Moreover, the media drive 1323 and the recording media 1333 may be integrated with each other to be configured of a non-transportable recording medium such as an integral hard disk drive or SSD (Solid State Drive).

The external interface 1319 is configured, for example, of a USE input/output terminal, and connected to the printer 1334 if an image is to be printed. Moreover, the external interface 1319 is connected to a drive 1331 as necessary to appropriately mount a removable media 1332 such as a magnetic disk, an optical disc, or a magneto-optical disk, and a computer program read out therefrom is installed in the FLASH ROM 1324 as necessary,

Furthermore, the external interface 1319 includes a network interface to be connected to predetermined networks such as a LAN and the Internet. For example, the controller 1321 can read out coded data from the DRAM 1318 in accordance with the instruction of the operation unit 1322 to supply the data to another device to be connected via a network from the external interface 1319. Moreover, the controller 1321 can acquire coded data and image data, which are supplied from another device via a network, via the external interface 1319 to cause the DRAM 1318 to hold or supply to the image signal processing unit 1314.

The camera 1300 described above uses the image decoding apparatus 200 as the decoder 1315. In short, similarly to the case of the image decoding apparatus 200, the decoder 1315 decides a size in the horizontal direction of a macroblock by use of the macroblock size information, the flag information, or the like, which is extracted from the coded data supplied from the image coding apparatus 100, and performs inter coding by use of the setting. Therefore, the decoder 1315 can further improve the coding efficiency while suppressing an increase in the load.

Therefore, the camera 1300 can improve the coding efficiency, for example, of image data to be generated in the CCD/CMOS 1312, coded data of video data to be read out from the DRAM 1318 or the recording media 1333, and coded data of video data to be acquired via a network while suppressing an increase in the load, and realize a real time process at lower cost.

Moreover, the camera 1300 uses the image coding apparatus 100 as the encoder 1341. Similarly to the case of the image coding apparatus 100, while fixing a size in the vertical direction of a macroblock, the encoder 1341 sets a size in the horizontal direction thereof depending on various parameters. The coding of image data by use of a predicted image generated by use of the macroblock set in this manner enables the encoder 1341 to further improve the coding efficiency while suppressing an increase in the load.

Therefore, the camera 1300 can improve the coding efficiency, for example, of coded data to be recorded in the DRAM 1318 and the recording media 1333 and coded data to be supplied to another device while suppressing an increase in the load, and realize a real time process at lower cost.

The decoding method of the image decoding apparatus 200 may be applied to a decoding process to be performed by the controller 1321. Similarly, the coding method of the image coding apparatus 100 may be applied to a coding process to be performed by the controller 1321.

Moreover, image data to be imaged by the camera 1300 may be a moving image or still image.

Naturally, the image coding apparatus 100 and the image decoding apparatus 200 can be applied to a device and a system other than the above-mentioned devices.

The present technology can take the following configurations:

(1) An image processing apparatus including:

a region setting unit for setting a size in a vertical direction of a partial region to be a process unit upon coding an image as a fixed value and setting a size in a horizontal direction of the partial region depending on a value of a parameter of the image;

a predicted image generation unit for generating a predicted image using the partial region set by the region setting unit as a process unit; and

a coding unit for coding the image by use of a predicted image generated by the predicted image generation unit.

(2) The image processing apparatus according to (1), wherein

the parameter of the image is a size of the image, and

the larger the size of the image is, the larger the region setting unit sets the size in the horizontal, direction of the partial region.

(3) The image processing apparatus according to any one of (1) and (2), wherein

the parameter of the image is a bit rate upon coding the image, and

the lower the bit rate is, the larger the region setting unit sets the size in the horizontal direction of the partial region.

(4) The image processing apparatus according to any one of (1) to (3), wherein

the parameter of the image is motion of the image, and

the smaller the motion of the image is, the larger the region setting unit sets the size in the horizontal direction of the partial region.

(5) The image processing apparatus according to any one of (1) to (4) wherein

the parameter of the image is an area of the same texture in the image, and

the larger the area of the same texture is in the image, the larger the region setting unit sets the size in the horizontal direction of the partial region.

(6) The image processing apparatus according to any one of (1) to (5) wherein the region setting unit sets a size specified in a coding standard as the fixed value.

(7) The image processing apparatus according to (6), wherein

the coding standard is the AVC (Advanced Video Coding) /H.264 standard, and

the region setting units sets the size in the vertical direction of the partial region to the fixed value of 16 pixels.

(8) The image processing apparatus according to any one of (1) to (7), further including a number-of-divisions setting unit for setting the number of divisions of the partial region where the size in the horizontal direction is set by the region setting unit.

(9) The image processing apparatus according to any one of (1) to (8), further including a feature value extraction unit for extracting a feature value from the image,

wherein the region setting unit sets the size in the horizontal direction of the partial region depending on a value of the parameter included in a feature value of the image, the feature value being extracted by the feature value extraction unit.

(10) The image processing apparatus according to (1) to (9), wherein

the predicted image generation unit performs inter-frame prediction and motion compensation to generate the predicted image, and

the coding unit codes a difference value between the image and the predicted image generated by the predicted image generation unit using the partial region set by the region setting unit as a process unit to generate a bit stream.

(11) The image processing apparatus according to any one of (1) to (10), wherein the coding unit transmits the bit stream and information showing the size in the horizontal direction of the partial region set by the region setting unit.

(12) The image processing apparatus according to any one of (1) to (11), further including a repeat information generation unit for generating repeat information showing whether the size in the horizontal direction of each partial region of a partial region line being a set of the partial regions lining up in the horizontal direction, the size being set by the region setting unit, is the same as the size in the horizontal direction of each partial region of a partial region line immediately above the partial region line,

wherein the coding unit transmits the bit stream and the repeat information generated by the repeat flag generation unit.

(13) The image processing apparatus according to any one of (1) to (12), further including a fixed information generation unit for generating fixed information showing whether the size in the horizontal direction of each partial region of a partial region line being a set of the partial regions lining up in the horizontal direction, the size being set by the region setting unit, is the same as each other,

wherein the coding unit transmits the bit stream and the fixed information generated by the fixed information generation unit.

(14) An image processing method of an image processing apparatus, including:

a region setting unit setting a size in a vertical direction of a partial region to be a process unit upon coding an image as a fixed value and setting a size in a horizontal direction of the partial region depending on a value of a parameter of the image;

a predicted image generation unit generating a predicted image using the set partial region as a process unit; and

a coding unit coding the image by use of the generated predicted image.

(15) An image processing apparatus including:

a decoding unit for decoding a bit stream where an image is coded;

a region setting unit for, based on information obtained by the decoding unit, setting a size in a vertical direction of a partial region to be a process unit of the image as a fixed value and setting a size in a horizontal direction of the partial region depending on a value of a parameter of the image; and

a predicted image generation unit for generating a predicted image using the partial region set by the region setting unit as a process unit.

(16) The image processing apparatus according to (15), wherein

the decoding unit obtains a difference image between the image and a predicted image generated from the image, the images using the partial region as a process unit, by decoding the bit stream, and

the predicted image generation unit generates the predicted image by performing inter-frame prediction and motion compensation and adds the predicted image to the difference image.

(17) The image processing apparatus according to any one of (15) and (16), wherein

the decoding unit acquires the bit stream and information showing the size in the horizontal direction of the partial region, and

the region setting unit sets the size in the horizontal direction of the partial region based on the information.

(18) The image processing apparatus according to any one of (15) to (17) wherein

the decoding unit acquires the bit stream and repeat information showing whether the size in the horizontal direction of each partial region of a partial region line being a set of the partial regions lining up in the horizontal direction is the same as the size in the horizontal direction of each partial region of a partial region line immediately above the partial region line, and

upon the size in the horizontal direction of each partial region being the same in the partial region line and the partial region line immediately above the partial region line, the region setting unit sets the size in the horizontal direction of the partial region to be the same as the size in the horizontal direction of the partial region immediately above based on the repeat information.

(19) The image processing apparatus according to any one of (15) to (18), wherein
the decoding unit, acquires the bit stream and fixed information showing whether the size in the horizontal direction of each partial region of a partial region line being a set of the partial regions lining up in the horizontal direction is the same as each other, and

upon the size in the horizontal direction of each partial region of the partial region line being the same as each other, the region setting unit, sets the size in the horizontal direction of each partial region of the partial region line to a common value based on the fixed information.

(20) An image processing method of an image processing apparatus, including

a decoding unit decoding a bit stream where an image is coded;

a region setting unit setting a size in a vertical direction of a partial region to be a process unit of the image as a fixed value and setting a size in a horizontal direction of the partial region depending on a value of a parameter of the image, based on the obtained information; and

a predicted image generation unit generating a predicted image using the set partial region as a process unit.

### REFERENCE SIGNS LIST

100 Image coding apparatus
115 Motion prediction/compensation unit
121 Feature value extraction unit
122 Macroblock setting unit
123 Flag generation unit
161 Motion prediction unit
162 Motion compensation unit
171 Parameter determination unit
172 Size decision unit
173 Number-of-divisions decision unit
181 Repeat flag generation unit
182 Fixed flag generation unit
200 Image decoding apparatus
202 Lossless decoding unit
212 Motion prediction/compensation unit
221 Macroblock setting unit
261 Motion prediction unit
262 Motion compensation unit
271 Flag determination unit
272 Size decision unit
273 Number-of-divisions decision unit

1. An image processing apparatus comprising:
a region setting unit for setting a size in a vertical direction of a partial region to be a process unit upon coding an image as a fixed value and setting a size in a horizontal direction of the partial region depending on a value of a parameter of the image;
a predicted image generation unit for generating a predicted image using the partial region set by the region setting unit as a process unit; and
a coding unit for coding the image by use of a predicted image generated by the predicted image generation unit.

2. The image processing apparatus according to claim 1, wherein
the parameter of the image is a size of the image, and
the larger the size of the image is, the larger the region setting unit sets the size in the horizontal direction of the partial region.

3. The image processing apparatus according to claim 1, wherein
the parameter of the image is a bit rate upon coding the image, and
the lower the bit rate is, the larger the region setting unit sets the size in the horizontal direction of the partial region.

4. The image processing apparatus according to claim 1, wherein
the parameter of the image is motion of the image, and
the smaller the motion of the image is, the larger the region setting unit sets the size in the horizontal direction of the partial region.

5. The image processing apparatus according to claim 1, wherein
the parameter of the image is an area of the same texture in the image, and
the larger the area of the same texture is in the image, the larger the region setting unit sets the size in the horizontal direction of the partial region.

6. The image processing apparatus according to claim 1, wherein the region setting unit sets a size specified in a coding standard as the fixed value.

7. The image processing apparatus according to 6, wherein
the coding standard is the AVC (Advanced Video Coding) /H.264 standard, and
the region setting unit sets the size in the vertical direction of the partial region to the fixed value of 16 pixels.

8. The image processing apparatus according to claim 1, further comprising a number-of-divisions setting unit for setting the number of divisions of the partial region where the size in the horizontal direction is set by the region setting unit.

9. The image processing apparatus according to claim 1, further comprising a feature value extraction unit for extracting a feature value from the image,
wherein the region setting unit sets the size in the horizontal direction of the partial region depending on a value of the parameter included in a feature value of the image, the feature value being extracted by the feature value extraction unit.

10. The image processing apparatus according to claim 1, wherein
the predicted image generation unit performs inter-frame prediction and motion compensation to generate the predicted image, and
the coding unit codes a difference value between the image and the predicted image generated by the predicted image generation unit using the partial region set by the region setting unit as a process unit to generate a bit stream.

11. The image processing apparatus according to claim 1, wherein the coding unit transmits the bit stream and information showing the size in the horizontal direction of the partial region set by the region setting unit.

12. The image processing apparatus according to claim 1, further comprising a repeat information generation unit for generating repeat information showing whether the size in the horizontal direction of each partial region of a partial region line being a set of the partial regions lining up in the horizontal direction, the size being set by the region setting unit, is the same as the size in the horizontal direction of each partial region of a partial region line immediately above the partial region line,
wherein the coding unit transmits the bit stream and the repeat information generated by the repeat information generation unit.

13. The image processing apparatus according to claim 1, further comprising a fixed information generation unit for generating fixed information showing whether the size in the horizontal direction of each partial region of a partial region line being a set of the partial regions lining up in the horizontal direction, the size being set by the region setting unit, is the same as each other,
wherein the coding unit transmits the bit stream and the fixed information generated by the fixed information generation unit.

14. An image processing method of an image processing apparatus, comprising:
a region setting unit setting a size in a vertical direction of a partial region to be a process unit, upon coding an image as a fixed value and setting a size in a horizontal direction of the partial region depending on a value of a parameter of the image;
a predicted image generation unit generating a predicted image using the set partial region as a process unit; and
a coding unit coding the image by use of the generated predicted image.

15. An image processing apparatus comprising:
a decoding unit for decoding a bit stream where an image is coded;
a region setting unit for, based on information obtained by the decoding unit, setting a size in a vertical direction of a partial region to be a process unit of the image as a fixed value and setting a size in a horizontal direction of the partial region depending on a value of a parameter of the image; and
a predicted image generation unit for generating a predicted image using the partial region set by the region setting unit as a process unit.

16. The image processing apparatus according to claim 15, wherein
the decoding unit obtains a difference image between the image and a predicted image generated from the image, the images using the partial region as a process unit, by decoding the bit stream, and
the predicted image generation unit generates the predicted image by performing inter-frame prediction and motion compensation and adds the predicted image to the difference image.

17. The image processing apparatus according to claim 15, wherein
the decoding unit acquires the bit stream and information showing the size in the horizontal direction of the partial region, and
the region setting unit sets the size in the horizontal direction of the partial region based on the information.

18. The image processing apparatus according to claim 15, wherein
the decoding unit acquires the hit stream and repeat information showing whether the size in the horizontal direction of each partial region of a partial region line being a set of the partial regions lining up in the horizontal direction is the same as the size in the horizontal direction of each partial region of a partial region line immediately above the partial region line, and
upon the size in the horizontal direction of each partial region being the same in the partial region line and the partial region line immediately above the partial region line, the region setting unit sets the size in the horizontal direction of the partial region to be the same as the size in the horizontal direction of the partial region immediately above based on the repeat information.

19. The image processing apparatus according to claim 15, wherein
the decoding unit acquires the bit stream and fixed information showing whether the size in the horizontal direction of each partial region of a partial region line being a set of the partial regions lining up in the horizontal direction is the same as each other, and
upon the size in the horizontal direction of each partial region of the partial region line being the same as each other, the region setting unit sets the size in the horizontal direction of each partial region of the partial region line to a common value based on the fixed information.

20. An image processing method of an image processing apparatus, comprising:
a decoding unit decoding a bit stream where an image is coded;
a region setting unit setting a size in a vertical direction of a partial region to be a process unit of the image as a fixed value and setting a size in a horizontal direction of the partial region depending on a value of a parameter of the image, based on the obtained information; and
a predicted image generation unit generating a predicted image using the set partial region as a process unit.
